(19) United States
(12) Patent Application Publication
(10) Pub. No.: US 2003/0182463 A1
(43) Pub. Date: Sep. 25, 2003

(54) Dynamic thin client for information management system

(76) Inventor: Jeffrey W. Valk, Dallas, TX (US)

Correspondence Address: SLATER & MATSIL, L.L.P., 17950 PRESTON RD, SUITE 1000, DALLAS, TX, 75252-5793, US

(21) Appl. No.: 10/396,599

(22) Filed: Mar. 25, 2003

Related U.S. Application Data
(60) Provisional application No. 60/367,178, filed on Mar. 25, 2002.
(60) Provisional application No. 60/403,327, filed on Aug. 13, 2002.

(51) Int. Cl. G06F 15/163; G06F 9/00

(52) U.S. Cl. 709/310; 709/328

(57) ABSTRACT

A method of providing a software application to a user at a client via a web browser from a server, is provided. The method includes the following steps, the order of which may vary. After the user first goes to a specified URL corresponding to the server, computer-executable code is generated in a scripting language at the server. The scripting language is capable of being interpreted and run on the web browser at the client without using server resources. The code includes static libraries and dynamically generated libraries of functions. The generated code is sent to the client over the Internet. The code is executed on the web browser at the client using client resources to provide the software application to the user at the client via the web browser.

### CROSS-REFERENCE TO RELATED APPLICATION

This application claims the priority benefit of commonly owned U.S. Provisional Patent Application having Ser. No. 60/367,178 entitled DATABASE SYSTEM FOR USE IN BUSINESS MANAGEMENT AND CORE ALGORITHMS AND ARCHITECTURE FOR THE DATABASE SYSTEM filed on Mar. 25, 2002, which is hereby incorporated by reference.

This application claims the priority benefit of commonly owned U.S. Provisional Patent Application having Ser. No. 60/403,327 entitled CORE ALGORITHMS AND ARCHITECTURE FOR INFORMATION MANAGEMENT SYSTEM filed on Aug. 13, 2002, which is hereby incorporated by reference.

This application is related to a commonly owned U.S. Patent Application having Ser. No. ______ entitled STATELESS CURSOR FOR INFORMATION MANAGEMENT SYSTEM filed on Mar. 25, 2003, having Attorney Docket Number MYR-004, and which is hereby incorporated by reference.

This application is related to a commonly owned U.S. Patent Application having Ser. No. ______ entitled SYSTEM ARCHITECTURE FOR INFORMATION MANAGEMENT SYSTEM filed on Mar. 25, 2003, having Attorney Docket Number MYR-006, and which is hereby incorporated by reference.

This application is related to a commonly owned U.S. Patent Application having Ser. No. ______ entitled INFORMATION MANAGEMENT STRUCTURE filed on Mar. 25, 2003, having Attorney Docket Number MYR-007, and which is hereby incorporated by reference.

### TECHNICAL FIELD

The present invention relates to software for organizing and accessing information, as well as for business management through the effective use of the information. In one aspect, it relates to a web-based application with the robust functionality of a desktop application for organizing and accessing information for use in business management.

### BACKGROUND

There are many database systems and information management systems currently available. But most existing systems are not flexible and easily adaptable to different business models. Also, most of such systems are not well suited for being web-based applications that may be run over the Internet on a relatively small computer system (e.g., an older laptop computer or a hand-held computer device) and over a relatively slow connection (e.g., wireless, satellite, or modem connection). Making changes to or adapting most existing systems to a new business model or making changes for an evolving business model often requires a team of software developers, months of lead time, and thus lots of money. Such expense and lead time is often not feasible for a small business, and is undesirable to even the largest of companies that are looking for ways to save time and money on overhead resources.

Most current web-based applications open and maintain a session for each user on the web server. A session is a way of preserving state within an application or within memory on a server. Because sessions require an allocation of server resources for each user, the use of sessions usually limits the number of users that may be using the resources or applications being provided by the server. For example, if a user performs a search or query that returns 1000 hits, the server will likely only send 20 or 50 of the hits down to the user at a time. If the user is viewing records 30-49, for example, the server resources may still be tied up with the 1000 hits and keeping track of the current state (that the user is viewing hits 30-49 of that 1000 hits). A session may also maintain the log-in information or credentials of the user. This paradigm is fine if the server has the ability and resources to store all the 1000 hits on the server and then send records down to the user on demand and the client remains connected. However, this paradigm has security and reliability risks.

In the context of a web-based application where the user is interacting via a browser, HTTP is inherently “stateless” because a user does not actually stay connected to the web server. For example, if a user is logged on via a web browser over the Internet and the user requests a web page, the web server receives the request, fulfills the request, sends the page back to the user, the user's browser receives the HTTP code and renders it. After receiving the information from the web server, the connection between the user and the web server is terminated. This happens every time the user requests information from the web server because it is built into the rules of engagement for the HTTP protocol. But for every user that is logged onto the web server and authenticated, the web server has to store an object in memory that keeps track of all of the users' privileges and where that user is within the application.

A security implication is that if someone wants to bring down the server, he or she may log on with as many simultaneous sessions as possible. The server will create multiple, additional session objects until all of the server's memory is consumed, at which point the server crashes and/or other users are blocked from using the server (denial of service scenario). Even if not in a malicious attack situation, the same scenario has scalability implications in the case where the number of users exceeds expected capacity. Rather than just filling requests and releasing the resources for further requests, the resources get consumed with sessions maintaining the state of many users.

For the reasons discussed above, sessions are often time limited. For example, a time limited session may only retain a user's session for 15 minutes, after which the user will have to log in and restart the prior query. In a business driven application for example, a user may keep an application open in a browser all day long for use at different times throughout the day, as needed. But if the session expires every 15 minutes, it would likely annoy the user to log in each time the application is needed throughout the day. If the server does not limit the allocation of resources in such a way, the reliability of the system may be compromised because the server may eventually crash when the limits of its resources are exceeded. An alternative is to continue to increase system resources at the server, which becomes expensive and more difficult to manage. Thus, there is a need for a way to keep track of a user's state without having a session that ties up server resources.

It is becoming highly desirable for business applications to be capable of running on a web browser over the Internet for a number of reasons. With a web enabled business application, the user may have access to the Internet from virtually any location in the world. Also, a web enabled application may be continuously upgraded and improved without the need to redistribute new versions of the software on discs (e.g., magnetic media, optical media). Users typically prefer not to waste time and energy loading software on their computers every time the software is improved or every time existing bugs are fixed. However, one of the limiting factors for web enabled applications is the speed and bandwidth of a user's connection. For a user sitting in an office building connected to a high speed network connection, this is not such a problem. However, for users that travel or work in the field, their connection speeds are often quite limited. Hence, there is a need for a way to provide web based business applications that minimizes the amount of code and data passed down to the user, as well as limiting the amount of information sent up to the server from the user.

Another limiting factor for web enabled applications is the amount of memory available on the user's computer. Thus, it is desirable that any code, tables, and applications sent down to a user be compact and able to run on a wide variety of computers (i.e., older computers with limited RAM and processor speed, as well as newer computers with lots of RAM and high speed processors).

Therefore, there are two sides to the coin for a web based business application. There is a desire to minimize the use of server resources so that a given server may handle many more users with the same resources and so that the users' states are maintained. But this needs to be accomplished without overloading a user's resources and without the need to shuttle large amounts of information back and forth between the user and server. On the flip side of that coin, there is a desire to provide business applications to users over the web via a browser with lots of features and functionality, with access to lots of information, while tying together many remotely located users, and while maintaining the users' sessions and states. But this needs to be done without tying up server resources over long periods of time or for large sets of data. In other words, it is desirable to provide web-based applications without increasing the amount of resources needed at the server end nor at the user end, and users certainly do not want to wait for large amounts information to be shuffled between the server and the client. Hence, the challenge is to create a software solution that can perform complex tasks, can run quickly even in the most remote locations on low-bandwidth for smaller companies, yet remain robust enough to handle the myriad of complicated needs facing multi-billion dollar organizations.

### SUMMARY OF INVENTION

The problems and needs outlined above are addressed by embodiments of the present invention. In accordance with one aspect of the present invention, a method of providing a software application to a user at a client via a web browser from a server, is provided. The method includes the following steps, the order of which may vary. After the user first goes to a specified URL corresponding to the server, computer-executable code is generated in a scripting language at the server. The scripting language is capable of being interpreted and run on the web browser at the client without using server resources. The code includes static libraries and dynamically generated libraries of functions. The generated code is sent to the client over the Internet. The code is executed on the web browser at the client using client resources to provide the software application to the user at the client via the web browser.

In accordance with another aspect of the present invention, a method for providing functionality to a client by a server across a networked communication medium, is provided. This method includes the following steps, the order of which may vary. A client-request is received from the client at the server. The client-request is based on a request inputted by a user. A set of computer-executable codes is generated by the server for providing functionality corresponding to the client-request after receiving the client-request. The generated set of computer-executable codes is forwarded to the client for execution. The functionality is provided to the user by the client.

In accordance with yet another aspect of the present invention, a method for providing functionality to a user by a client based on a user inputted request, is provided. This method includes the following steps, the order of which may vary. The user-inputted request is forwarded to a server in communication with the client across a networked communication medium. A set of computer-executable codes generated by the server for providing functionality at the client is received from the server. The received set of computer-executable codes are executed by the client. The functionality is provided to the user by the client.

In accordance with still another aspect of the present invention, a method for interacting between a server and a client across a networked communication medium for providing functionality to the client by the server, is provided. This method includes the following steps, the order of which may vary. A client-request for the functionality is forwarded to the server by the client. The client-request is based on a request inputted by a user. The client-request is received by the server. A set of computer-executable codes is generated by the server for providing the functionality after receiving the client-request. The generated set of computer-executable codes is forwarded to the client. The forwarded set of computer-executable codes is received by the client. The received set of computer-executable codes is executed by the client. The functionality to the user is provided by the client. In accordance with another aspect of the present invention, a method for providing functionality to a client by a server across a networked communication medium, is provided. A client-request is received from the client at the server. The client-request is based on a request inputted by a user. A set of computer-executable codes is generated by the server for providing functionality corresponding to the client-request after receiving the client-request. The generated set of computer-executable codes is forwarded to the client for execution, wherein the functionality is provided to the user by the client. The server communicates with the client based on an initial request by the client prior to receiving the client-request. The communication by the server with the client is terminated subsequent to the forwarding. The functionality is provided to the user by the client after the terminating.

In accordance with another aspect of the present invention, a method of providing functionality and presenting information to a user by a client, is provided. This method includes the following steps, the order of which may vary. An initial client communication is received over a networked communication medium from the client at a server. A first set of computer-executable code including a set of system-level logic is forwarded to the client by the server. The first set of code is executed by the client for instantiating the system-level logic at the client. An information insight request is received from the client at the server. The information insight request is based on a user input at the client. A set of computer-executable codes is generated by the server. The second set of computer-executable code is adapted to fulfill the information insight request. The second set of code includes a set of process-specific logic, a set of schema-specific logic corresponding to the functionality, and a set of information objects. The second set of computer-executable codes is forwarded to the client by the server. The second set of computer-executable codes is executed by the client. At least part of the set of information objects is presented to the user by the client. Functionality is provided by the client so that the user can interact with the presented objects in accordance with the schema-specific logic.

### BRIEF DESCRIPTION OF THE DRAWINGS

The above features of the present invention will be more clearly understood from consideration of the following descriptions in connection with accompanying drawings in which:

FIGS. 1-10 are simplified screen shots of graphical user interface presentations generated by a first embodiment of the present invention;

FIG. 11 is a schematic of an overall system architecture for the first embodiment of the present invention;

FIG. 12 is a schematic of the overall system architecture of FIG. 11, focusing on the Interactive Services architecture;

FIG. 13 is a schematic of the overall system architecture of FIG. 11, focusing on the Insight Services architecture;

FIG. 14A is a diagram showing a high-level overview of the general architecture for the Dynamic Thin Client;

FIG. 14B is an implementation of the general architecture shown in FIG. 14A in accordance with the first embodiment; and

FIGS. 15-17 are flowcharts showing a Stateless Cursor Algorithm of the first embodiment.

### DETAILED DESCRIPTION OF PREFERRED EMBODIMENTS

Referring now to the drawings, wherein like reference numbers are used herein to designate like elements throughout the various views, preferred embodiments of the present invention are illustrated and described. As will be understood by one of ordinary skill in the art, the figures are not necessarily drawn to scale, and in some instances the drawings have been exaggerated and/or simplified in places for illustrative purposes only. One of ordinary skill in the art will appreciate the many applications and variations of the present invention in light of the following description of preferred embodiments of the present invention.

Because embodiments of the present invention generally relate to software for organizing and accessing information, as well as for business management through the effective use of the information, such embodiments may be applied to a myriad of fields. Essentially, any field or business where information and data regarding that field or business needs to be organized and easily accessed or where such information may be useful in business management, an embodiment of the present invention may be useful and highly desirable.

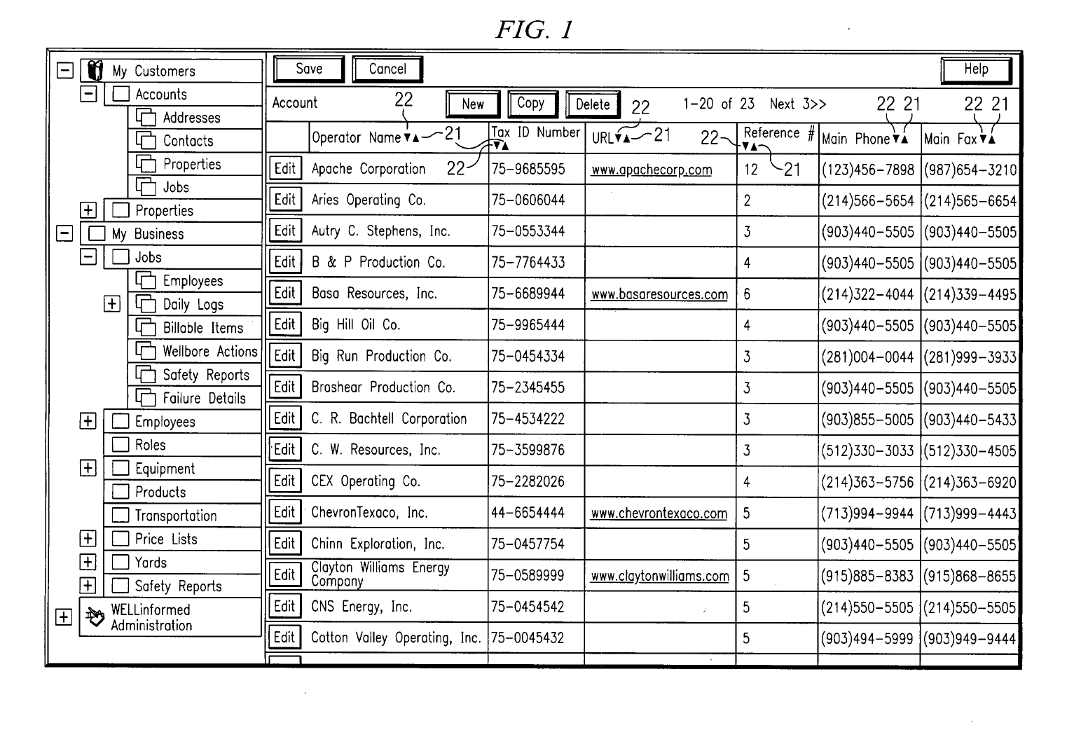

As just one example, oil well services is a field where a business may benefit from the use of an embodiment of the present invention. FIGS. 1-13 and 14B-17 pertain to a first embodiment of the present invention, as applied to the field of oil well services. The example provided by the first embodiment will be used to illustrate and explain-by-example the more general concepts, core algorithms, and system architecture of the present invention.

An oil well services company may need to keep track of numerous pieces of equipment being used at numerous sites by a variety of employees and/or contractors. Also, the billing, progress statuses, deadlines, safety records, and worker training statuses, for example, are just some of the information of interest in managing such a company. To best use the information, the information needs to be organized and easily accessible. One of the advantages of the first embodiment is that the relevant information is input and stored at a centralized data repository, which may be edited and accessed easily from virtually any remote location in the world (e.g., anywhere Internet access may be obtained).

FIGS. 1-10 are simplified screen shots generated by the first embodiment of the present invention, which illustrate example views of graphical user interfaces that may be provided to a user via the user's browser. Because the present invention may be implemented into any browser application and for purposes of simplifying the views shown, the standard browser buttons and toolbars are not shown in FIGS. 1-10. An embodiment of the present invention may generate graphical user interfaces for commonly used browsers, including but not limited to: Microsoft Internet Explorer versions 5.0 or higher, Netscape version 6 and up, and Opera, for example. The interface presented on a browser is preferably presented on multiple frames, as shown herein, but an embodiment also may generate a user interface with in a non-frames context.

In FIG. 1, the left frame (navigation panel) lists different “insights” into the information. Generally, an “insight” is a group or collection of objects portrayed or gathered in a logically related and meaningful way. An “insight” may also be thought of as results from a query or series of queries into certain classes of data or into the entire data repository. In other words, the left frame shows a hierarchy and organization of different groups of information objects. Because there are so many different ways that information objects may be logically and/or meaningfully related, there are also many different hierarchies and orders of organization that may be chosen. Hence, the hierarchy and grouping shown in FIG. 1 is just one among many possible hierarchies and groupings. In another embodiment (not shown), there may be only grouping and no hierarchies, for example, depending on the extent of the organizing provided. Many of the objects are interrelated due to the nature of the information in this example, but not all of the groups will necessarily be interrelated in other cases. Some of the groups contain subgroups or related insights, as indicated by the − and + signs. The plus sign indicates that the group contains subgroups and may be expanded to view the related insights therein. Whereas, the minus sign indicates that the expanded view of the subgroups may be hidden to reduce the number of groups shown in the left frame. In FIG. 1, the insight My Customers contains the sub-insights Accounts and Properties. The insight Accounts is expanded to reveal its sub-insights, whereas the insight Properties is compressed to hide its sub-insights.

The right frame in FIG. 1 shows the Accounts insight into the information (i.e., the information from the perspective of accounts). The properties shown for each object row in the Accounts insight frame were chosen due to their usefulness and their logical relationship in this oil well services example. The properties associated with each insight may be altered or edited to add, delete, or change the property or set of properties associated with each insight. In the example shown in FIG. 1, the following properties have been associated with the Accounts insight: Operator Name, Tax ID Number, URL, Reference #, Main Phone, and Main Fax. Note that there are up and down arrows 21, 22 next to each of the property names. The down arrow 22 is a button for invoking a descending sort of that property for the insight. The up arrow 21 is a button for invoking an ascending sort of that property for the insight. In FIG. 1, the Account insight has been sorted so that the values of the Operator Name property are in ascending order. Hence, if a user clicks on the up button next to the label “Operator Name” in FIG. 1, the entire Account insight would be sorted in ascending order (as in FIG. 1), even the values not shown. FIG. 1 illustrates this because the default sort property and sort order in this example are Operator Name and ascending order, respectively.

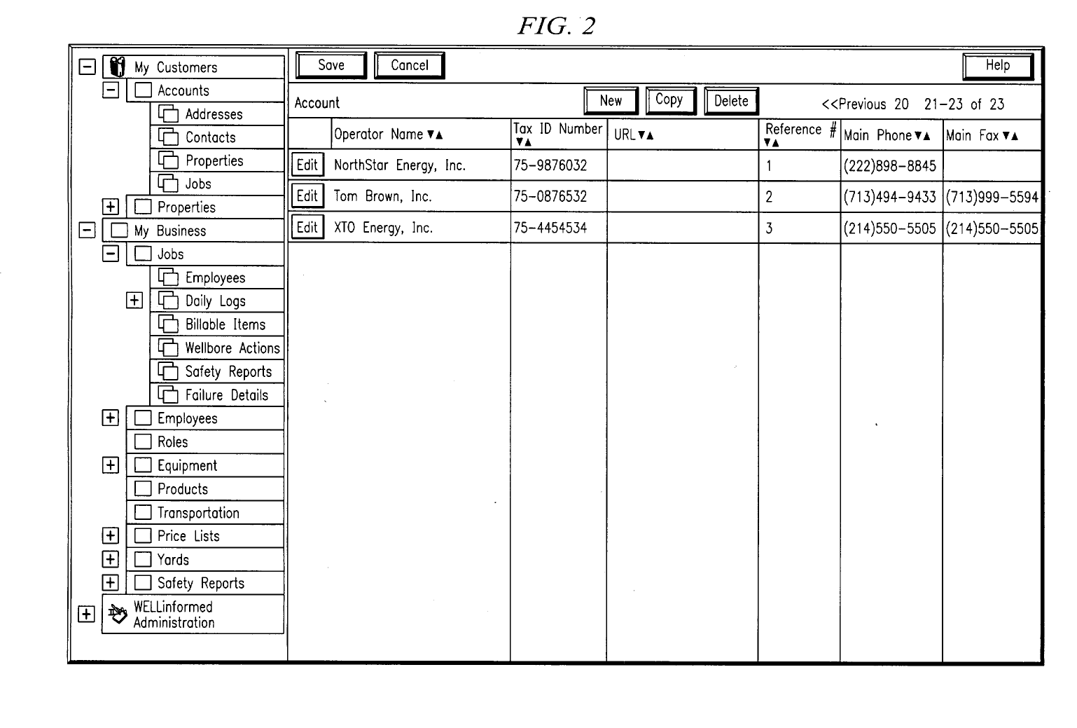

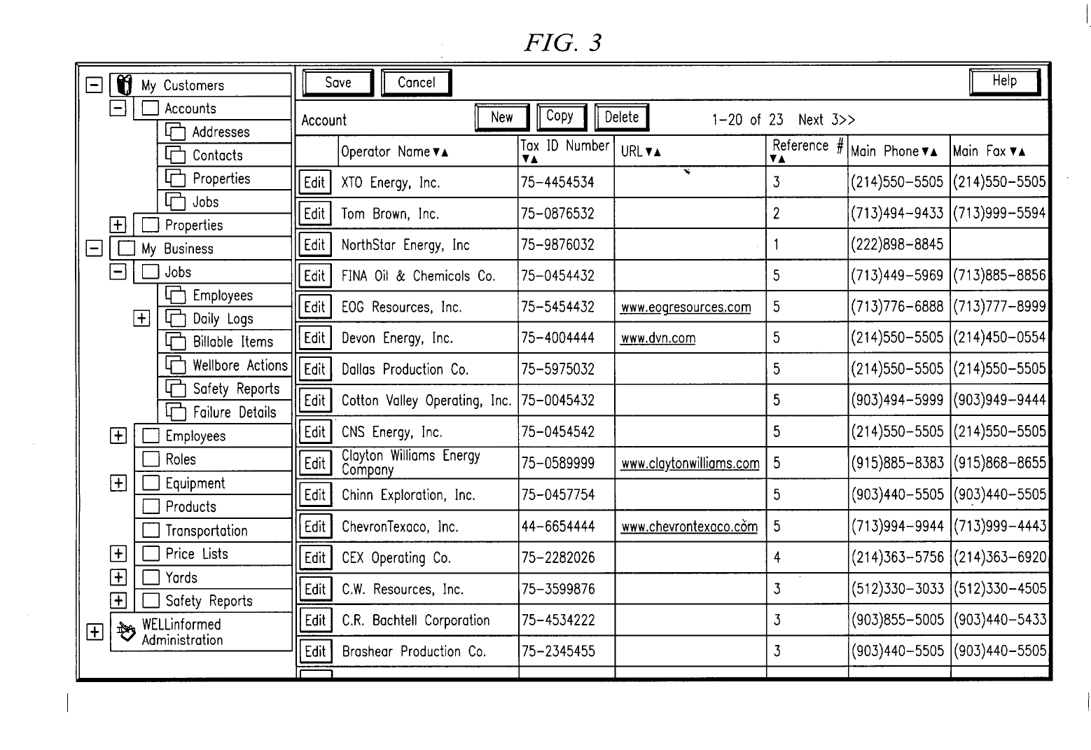

Note that also by default in this example, only 20 objects are shown in the right frame at a time. If a user wants or needs to see the next 3 objects of the 23 total objects in the account insight, the user may click on “Next 3>>” to display them, as shown in FIG. 2. Note that the objects shown in FIG. 2 are sorted in the same order as those shown in FIG. 1. Also, note that the left frame remained unchanged from FIG. 1 to FIG. 2. In FIG. 2, if the user wants or needs to return to the previous 20 objects, the user may click on “<<Previous 20” to display them, which would bring us back to FIG. 1. FIG. 3 shows the Account insight sorted so that the values of the Operator Name property are in descending order, such as when the user clicks on the down arrow 22 next to the label “Operator Name.”

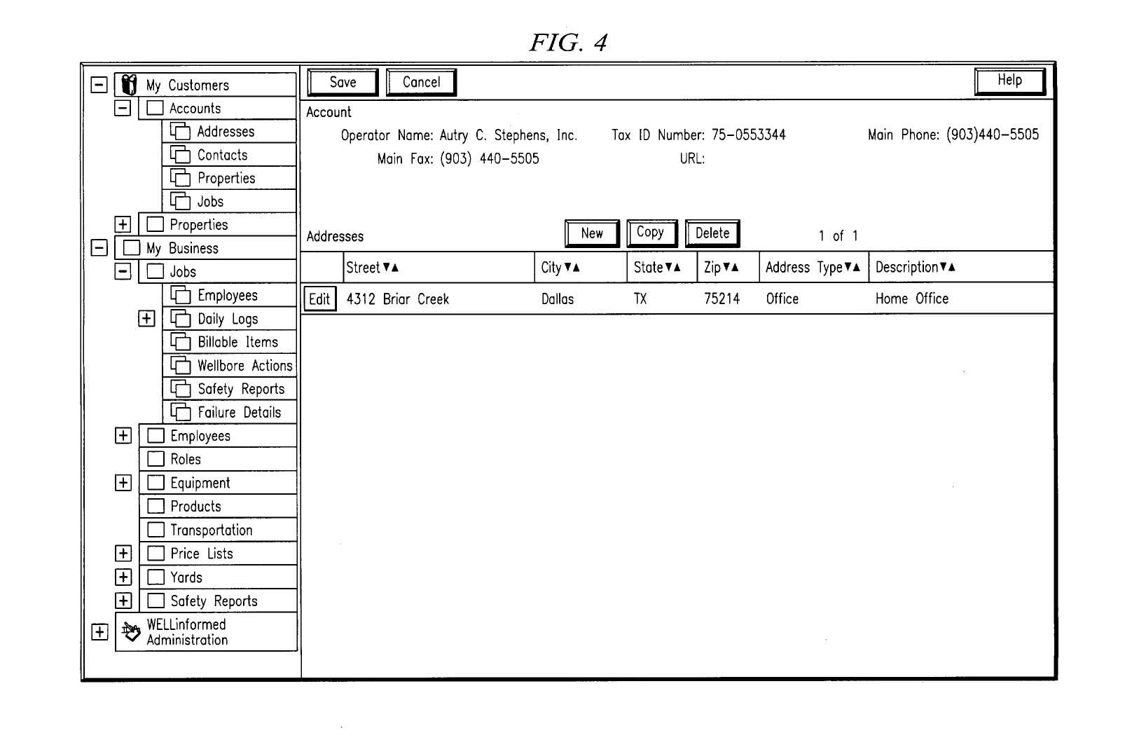

Referring again to FIG. 1, if the user wants or needs more information about the operator “Autry C. Stephens, Inc.” for example, the user may click on the row for Autry C. Stephens, Inc., which will select and highlight that row. Then, the user may choose from the subgroups under the Account insight shown in the left frame. If the user chooses the Addresses insight under Account in the left frame after selecting operator “Autry C. Stephens, Inc.,” then the Addresses insight for Autry C. Stephens, Inc. is shown in the right frame, as shown in FIG. 4. Thus, the user has drilled down or focused in on the value of “Autry C. Stephens, Inc.” to find other properties within the Address insight associated with or logically related to Autry C. Stephens, Inc. in the database. To return back to the Accounts insight shown in FIG. 1, the user may click on “Accounts” in the left frame or click on the back button on the browser toolbar (not shown).

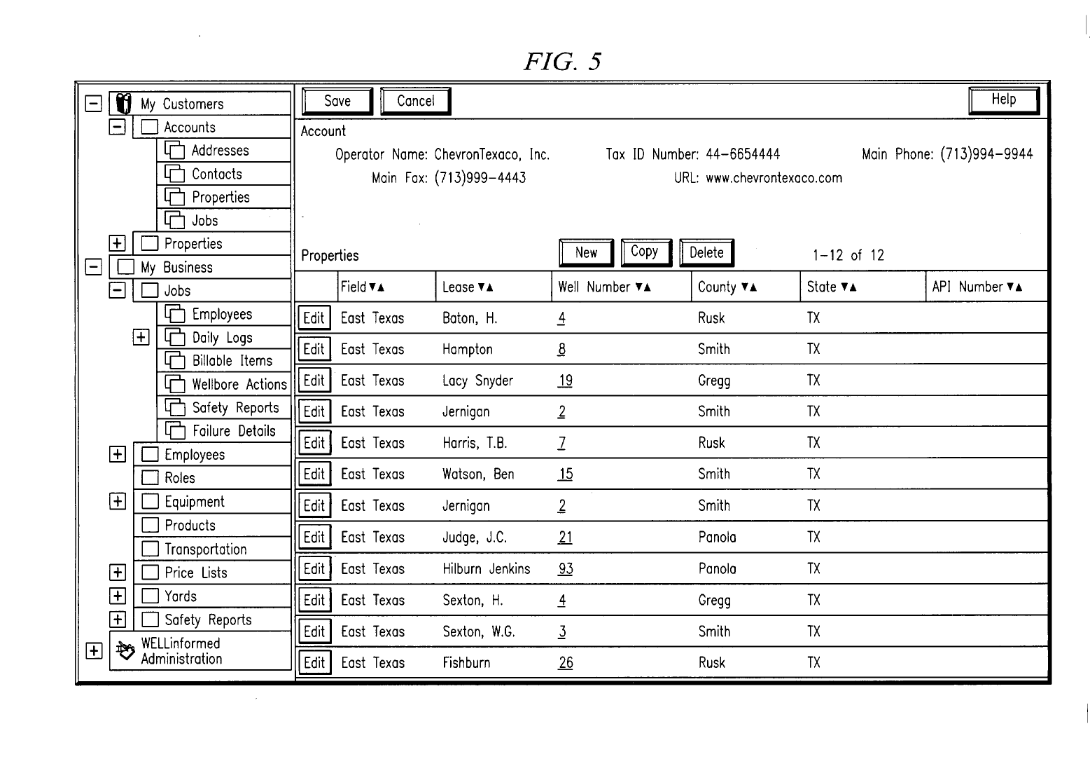

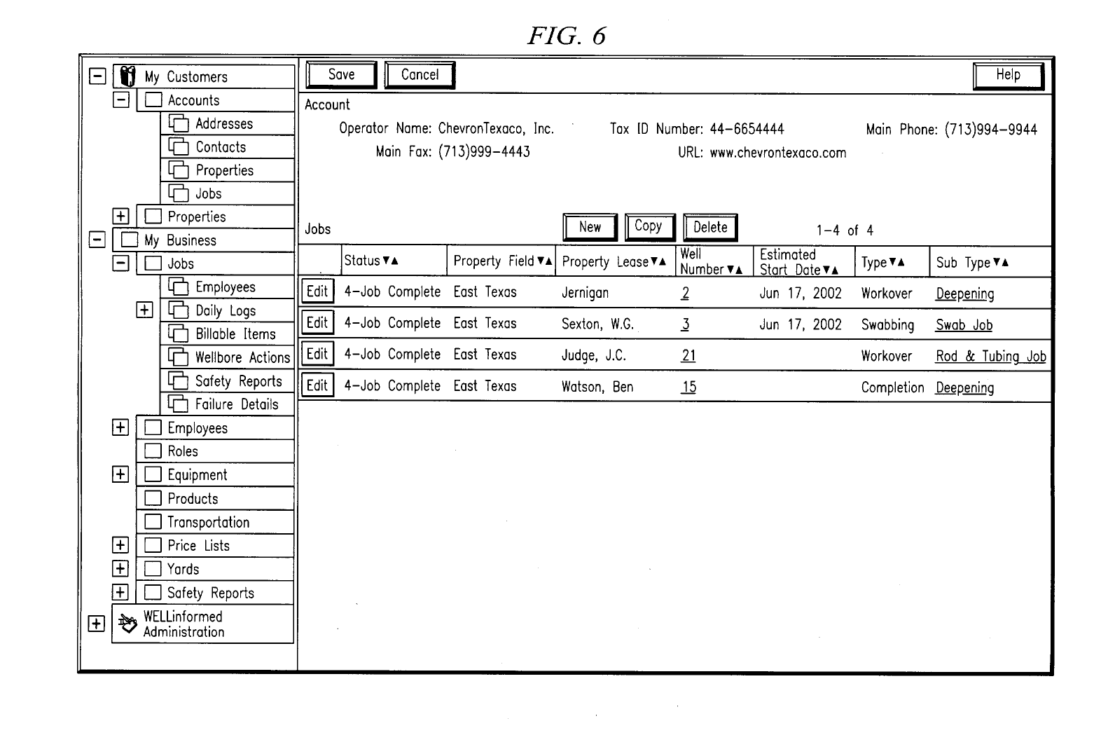

Referring again to FIG. 1, if the user wants or needs insight into the properties associated with ChevronTexaco, Inc. (shown in the right frame of FIG. 1), the user may select (or highlight) “ChevronTexaco, Inc.” and then click on “Properties” under “Accounts” in the left frame. This will invoke the Properties insight into ChevronTexaco, Inc., as shown in FIG. 5. Because the operator ChevronTexaco, Inc. is still selected, if the user now clicks on “Jobs” under “Accounts” in the left frame of FIG. 5, this will invoke the Jobs insight into ChevronTexaco, Inc., as shown in FIG. 6. Because there are many overlapping interrelationships in this data, there are also other ways of arriving at the Properties and Jobs insights for ChevronTexaco, Inc. For example, if the user selects the broader Properties insight directly under My Customers (rather than the more focused Properties insight under the Accounts insight), all of the properties will be shown, including all of ChevronTexaco's properties. Then, if the user selects ChevronTexaco, Inc. in the broader Properties insight, the software will focus the Properties insight on ChevronTexaco, Inc. and will provide the same screen presentation as that shown in FIG. 5.

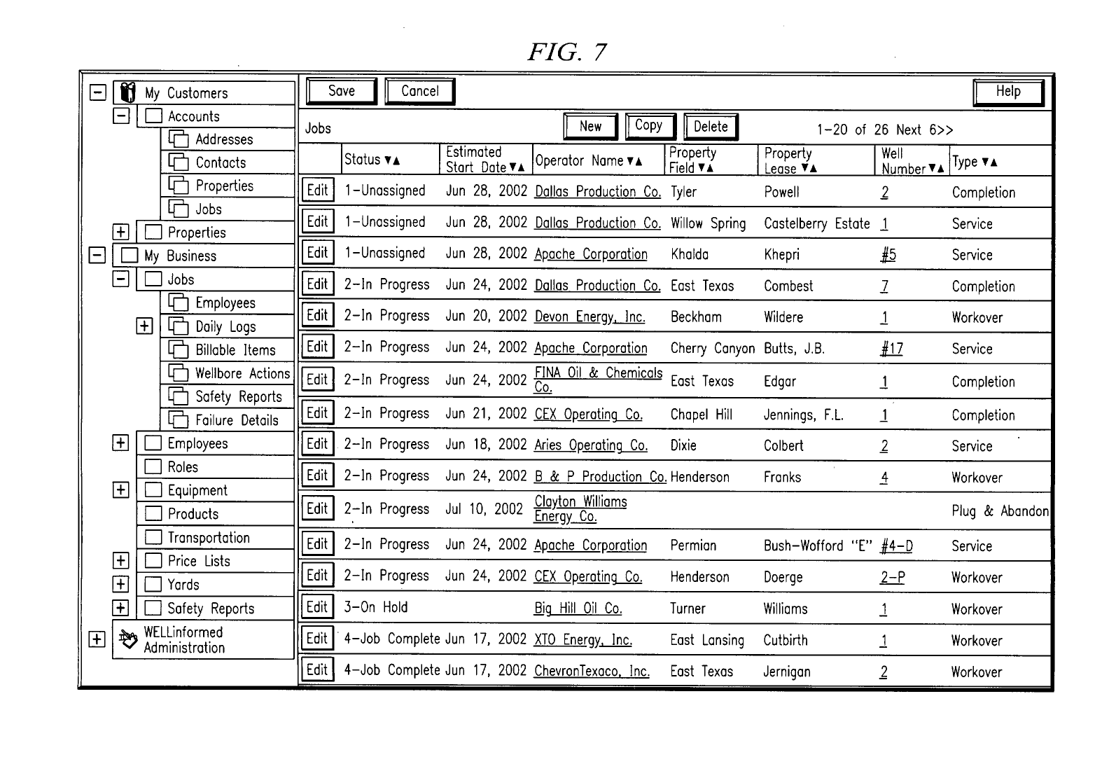

FIG. 7 is a screen shot illustrating the Jobs insight under the My Business insight (i.e., the user has clicked on “Jobs” under “My Business” in the left frame). The default for this Job insight has been setup to first display the Job insight with the values of the Status property sorted in ascending order (see right frame of FIG. 7). Note that in this Job insight in FIG. 7 is much broader than the Job insight shown in FIG. 6, which was only a Job insight into the operator ChevronTexaco, Inc. However, the Job insight shown in FIG. 7 may be narrowed or focused to provide more detail regarding certain values cross-referenced in this broader Job insight. Note that the values of the Operator Name property, as well as the values of the Well Number property, are hyperlinked (underlined and clickable link). If the user clicks on one of the Operator Name values, the software will provide a view of all jobs for that operator. For example, if the user clicks on ChevronTexaco, Inc. in the right frame of FIG. 7, the software will bring up a more detailed Job insight focused on the operator ChevronTexaco, Inc., which will be the same screen as shown in FIG. 6.

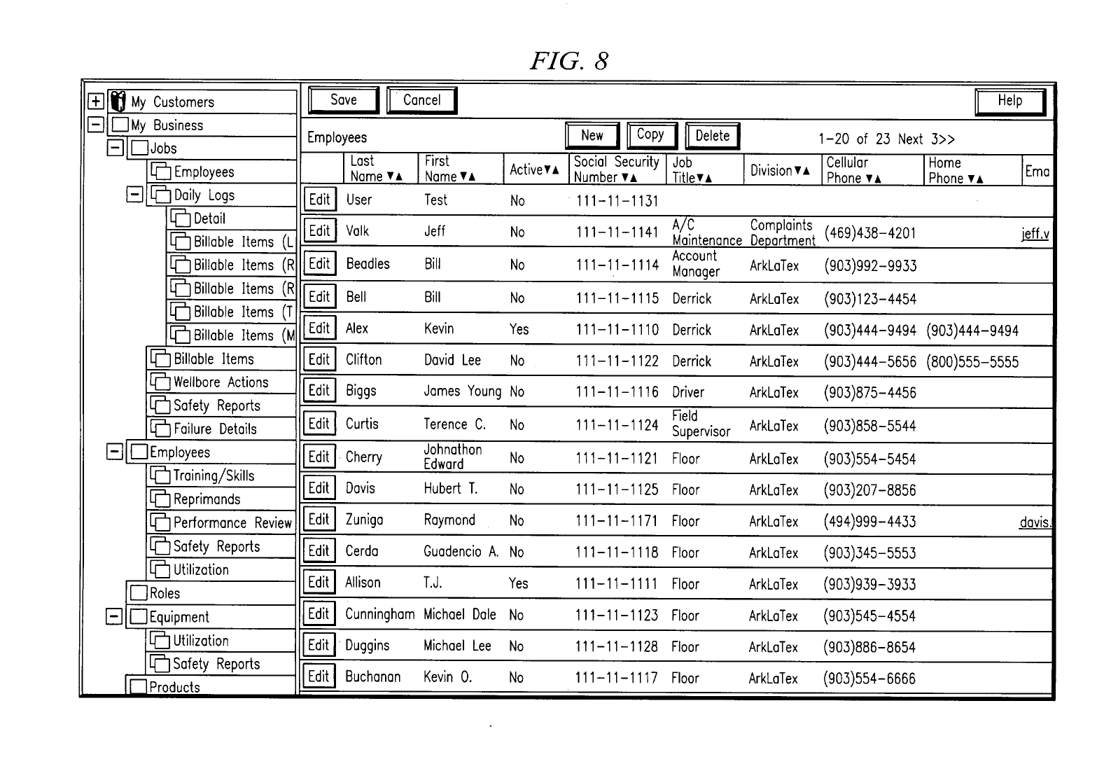

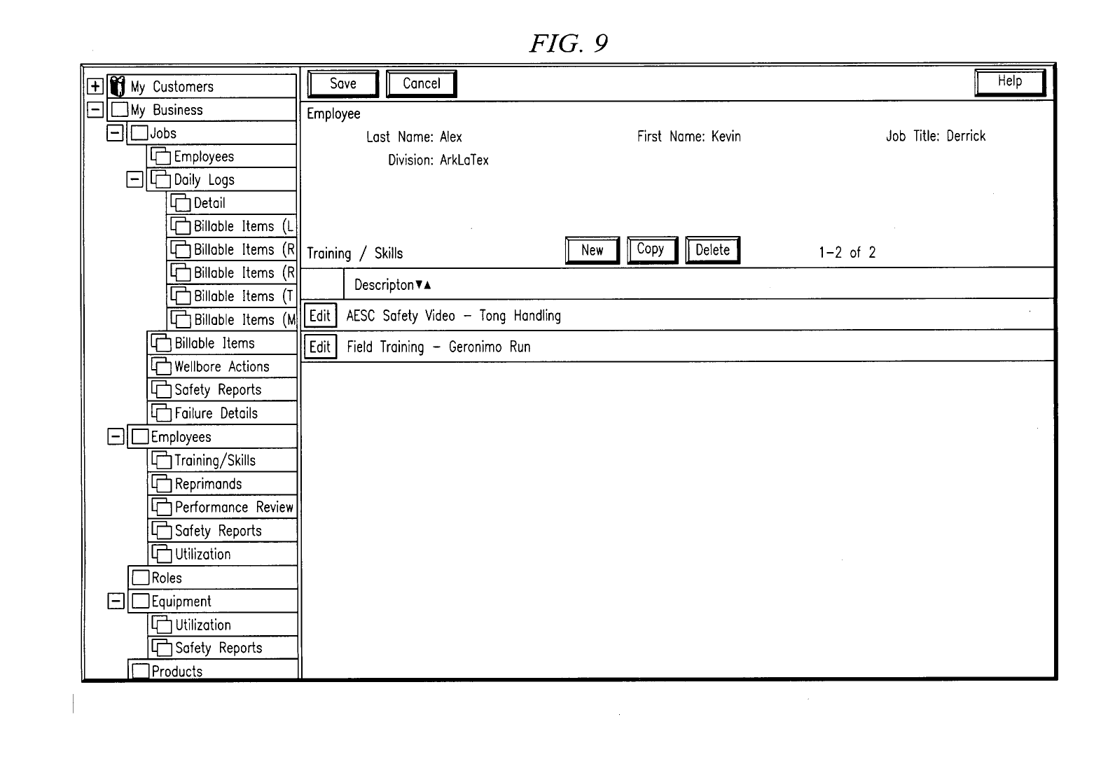

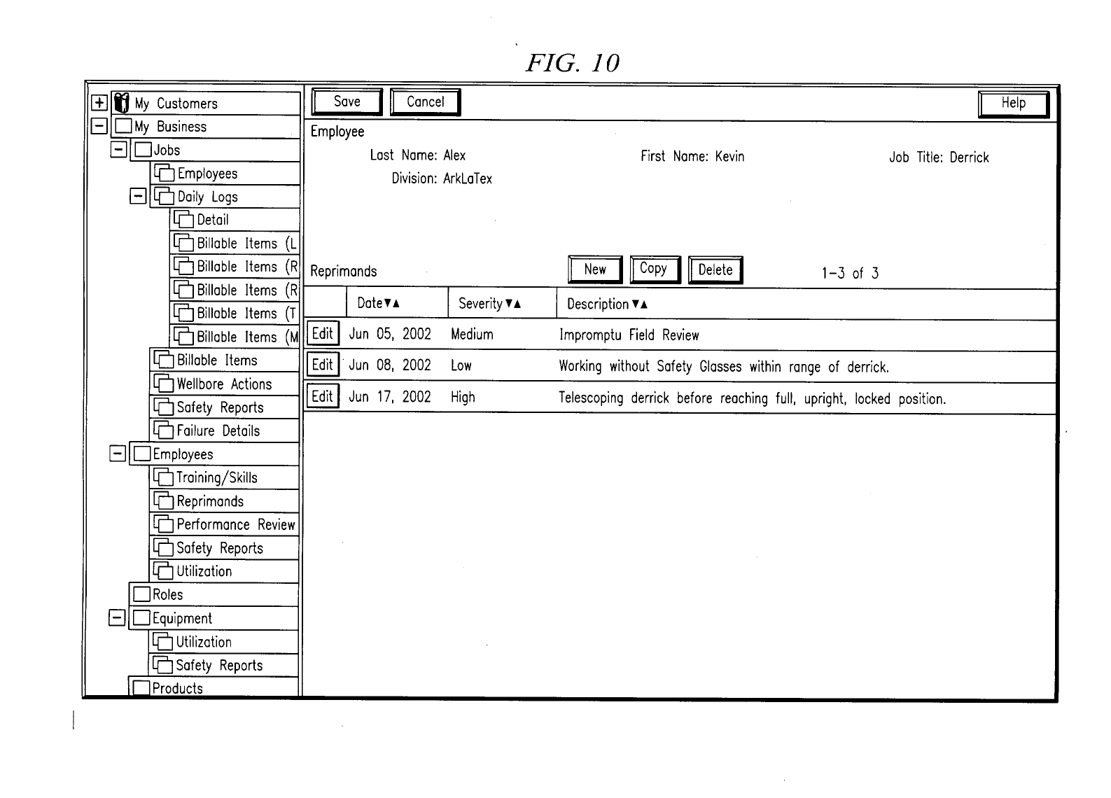

As an example of how a user may use the first embodiment to access information for business management, assume that the user is looking for a derrick worker while planning a future job. If the user selects the Employees insight under My Business in the left frame of FIG. 8, the software provides the information shown in the right frame of FIG. 8. Note in FIG. 8 that many of the insight group listings in the left frame have been expanded to show some of the other insights of the first embodiment. Again, the insights provided in an embodiment may vary completely for other applications to suit a user's needs or desires. Back to the example in FIG. 8, the user may sort the Employees insight by the Job Title property in ascending or descending order to group all of the derrick workers together. In FIG. 8, the Employees insight has been sorted by the Job Title property in ascending order. There are three derricks listed in FIG. 8. Now, if the user wants to know more detailed information about each of these derricks, the software puts such information at the user's fingertips. If the user selects Kevin Alex in the right frame (by clicking on his name to highlight his object row) and then clicks on Training/Skills under Employees in the left frame, a more focused insight into Kevin Alex's training and skills are listed, as shown FIG. 9. Hence, the information provided in FIG. 9 shows that Kevin Alex has had training in an AESC Safety Video about Tong Handling and field training at Geronimo Run. Note that there are other focused insights available as well under Employees in the left frame: Reprimands, Performance Reviews, Safety Reports, and Utilization. If the user wants to know about whether Kevin Alex has received any reprimands, the user may click on Reprimands under Employees in the left frame of FIG. 10, which will provide the Reprimand insight information, as shown in the right frame of FIG. 10. Thus in FIG. 10, the user can quickly see that Kevin Alex has had three reprimands with varying degrees of severity. Such information may be very helpful and useful to the user in choosing workers for a future job.

Different users may have different levels of access or different levels of insight into the data. Note that in FIGS. 1-10 that an Edit button is provided in the right frame next to each object row. Also note in the right frames of FIGS. 1-10 that New, Copy, and Delete buttons are provided. Hence, the user logged-in for FIGS. 1-10 has a lot of administrative access and authority to edit, add, copy, or delete properties and/or values. If, however, the user had less authority (i.e., read-only access), the edit, new, copy, and/or delete buttons may be hidden. Also, if the user's access needs to be limited, some of the insights may be hidden from that user. For simplicity, users may be divided into or categorized into user groups, where each user group has a different amount of access and editing authority. Some users groups may overlap, and some users may fall into two or more groups to provide the user with the proper amount of access and authority. Hence, a field worker may be able to input new Daily Log objects or to edit Daily Log objects that the worker created. But, such a field worker may have little or no access and/or editing authority for Employees insights, for example.

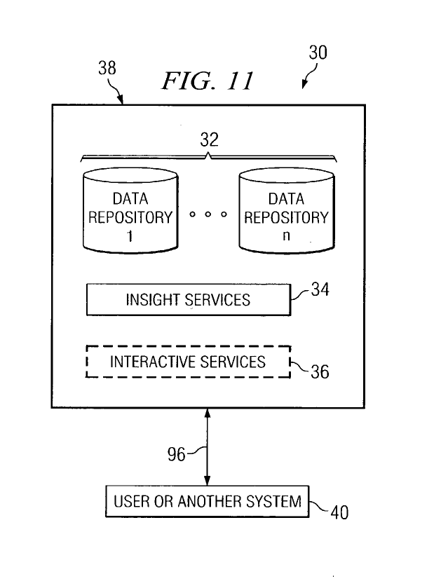

Although the user will typically only sees a graphical user interface, such as those shown in FIGS. 1-10, there is naturally a lot more to the system architecture of the first embodiment to provide the graphical user interface and functionality than what the user sees. FIGS. 11-13 and 14B-17, and the following will provide descriptions of the system architecture and core algorithms at the heart of the first embodiment.

FIG. 11 is a schematic of an overall system architecture 30 for the first embodiment of the present invention. The system architecture 30 includes a data repository 32 where data and information may be stored. The term data repository 32 is used in a general sense and should be construed to include conventional storage structures such as relational database management platforms, hierarchical database systems, and collections of flat files; advanced storage structures such as optical or biological systems, or any other manner of information structure capable of being read from and written to and storing information persistently. In addition, it should be noted that any number (i.e., one, two, or many) of these repositories may be used as information sources and recepticals for the herein described system. The Insight Services 34 and Interactive Services 36 are provided at the system server 38. The system server 38 may include any number (i.e., one, two, or many) of computers, of which may be located at any number (i.e., one, two, or many) of locations. A user or another system 40 may communicate with the system server 38 via the Interactive Services 36. Note that the term “client” may refer to a person's browser (user's browser) at a terminal or another system that is autonomously or semi-autonomously interacting with the system, for example.

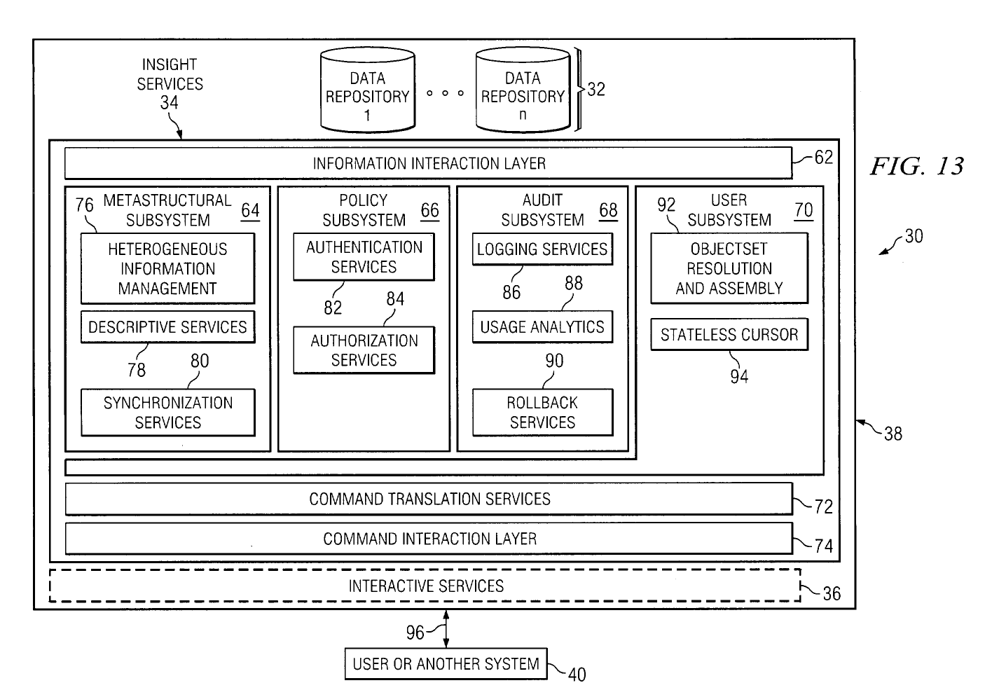

Still referring to FIG. 11, the Insight Services architecture 34 enables information from multiple sources to be accessed simultaneously and resolved to provide a unified portrayal of the information to the client. The Insight Services architecture 34 may interact with information sources disparate in both storage format and geography. The Insight Services architecture 34 does not assume the generation of data stores from scratch. Although this is the most common condition, attachment to an existing data store is just as feasible. The Insight Services architecture 34 may run information models as self-descriptive entities, storing large amounts of meta-information about the information. The meta-information may include the model internally and transparently to both the client and the original data store. Hence, meta-information is information about the information. For example, it is specified in the system software of the first embodiment that the insight Employees (see FIG. 8) has the properties Last Name, First Name, etc. associated with it. Such information about those associations is meta-information because it is not actually communicating values of the objects in the Employee insight, such as Kevin Alex is an employee. That Kevin Alex is an employee is information, not meta-information. The Insight Services 34 are further detailed below with respect to FIG. 13.

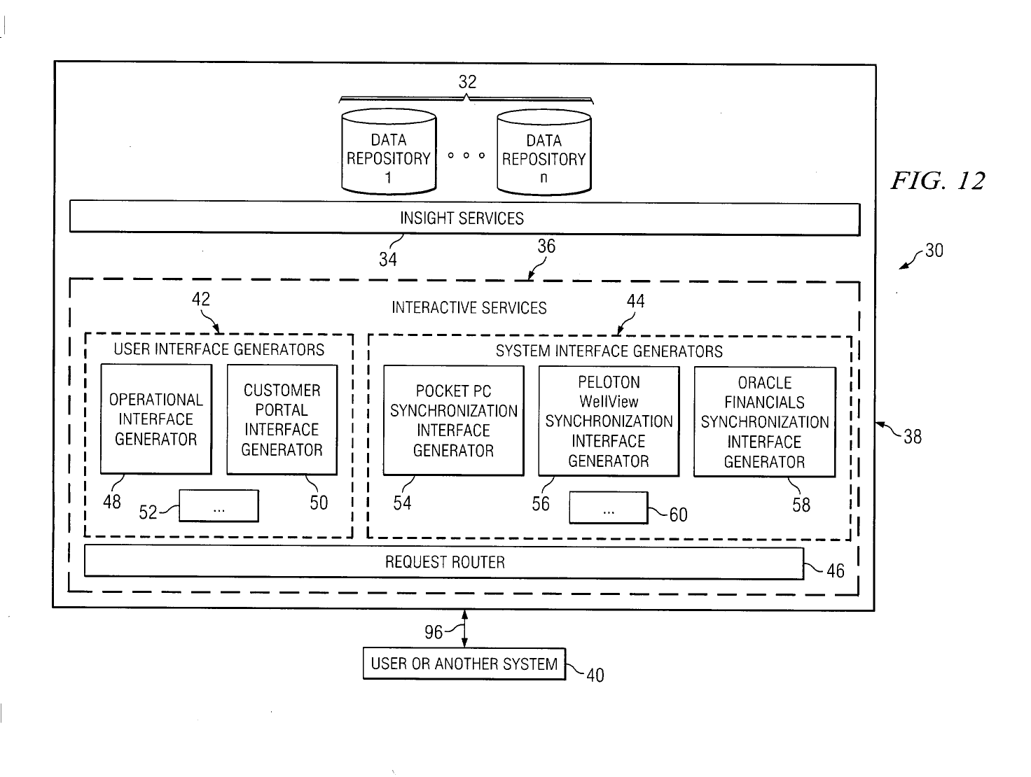

Referring to FIGS. 11 and 12, the Interactive Services architecture 36 does not have hard-coded interfaces, which is why the Interactive Services block in FIGS. 11 and 12 is shown in dashed lines. But rather, the individual interfaces (both the user interfaces 42 and the system interoperation interfaces 44) are generated on-demand based on logic compiled into interface generators, allowing them to be polymorphic and adapted to the capabilities of the requesting process' platform. Interface generators may be added, deleted, and/or altered to provide different types of interoperative services to various clients, devices, and/or other systems, even as the system is online and available.

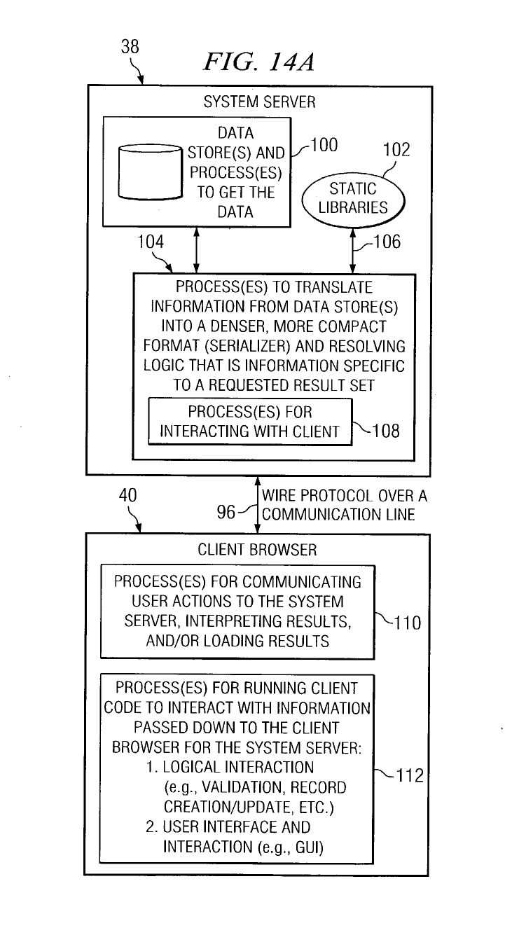

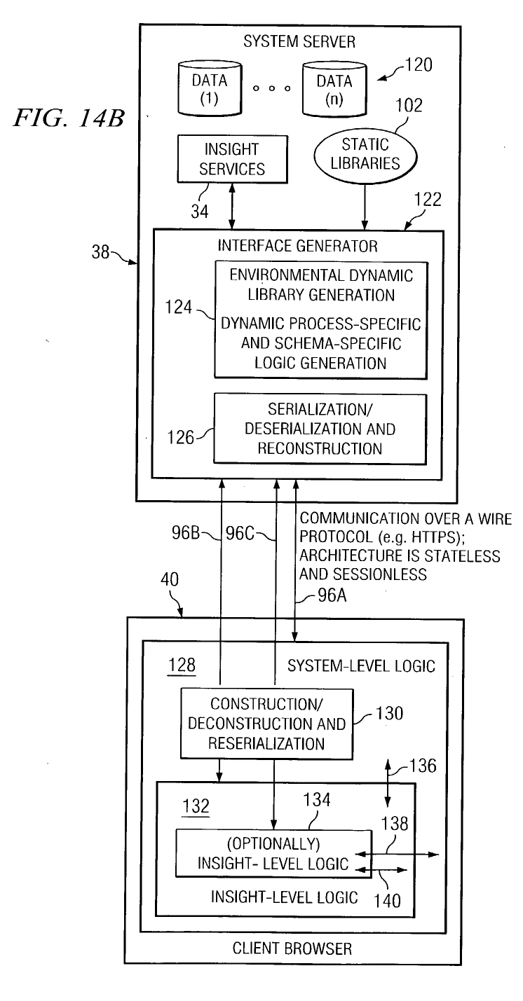

FIG. 12 is a schematic focusing on the Interactive Services architecture 36. The Interactive Services architecture includes user interface generators 42, system interface generators 44, and a request router 46. The user interface generators 42 are visual interface generators having logic for creating user interfaces (e.g., graphical user interfaces, browser interface screens and/or frames). The user interface generators 42 may include an operational interface generator 48 and a customer portal interface generator 50, for example. Other additional generators 52 and/or different alternative generators may be included as needed. One example of a user interface generator within the operational interface generator 48 is a Dynamic Thin Client architecture, which will be discussed in more detail below with respect to FIGS. 14A and 14B.

Still referring to FIG. 12, the system interface generators 44 include logic for creating non-visual or synchronization interfaces for interaction with disconnected clients or foreign systems. The system interface generators 44 may include (but are not limited to): a PocketPC synchronization interface generator 54, a Peloton WellView synchronization interface generator 56, and/or an Oracle Financials synchronization interface generator 58, for example. Other additional generators 60 and/or different alternative generators may be included as needed.

The request router 46 allows all user requests (and/or other system requests) to come in through a single universal resource indicator (URI) (e.g., universal resource locator—URL, universal resource name—URN), and routed to the correct resource by virtue of resource authorization and additional request information, if needed. The request router 46 is not shown in dashed lines because it is a fixed physical component, as opposed to interfaces generated on-the-fly (on demand). When a client submits a request to the Interactive Services 36, it comes in through the request router 46. The request router 46 first looks for credentials included in the request. Such credentials may include information needed by the router 46, such as platform type (e.g., browser, hand-held, etc.), user identification, user log-in information, and user privilege level, for routing the request to the proper interface generator within Interactive Services 36. If a credential is not provided or if insufficient information is provided in the credential, the request router may prompt the client for the information needed. Because Interactive Services 36 acts as a translator for requests moving upstream to the Insight Services 34, the request router 46 needs to route the request to the proper “translator” (i.e., the proper interface generator). For example, if a client submits a request from a browser platform, the request router 46 may route such request through the user interface generators 42. If a client submits a request from a hand-held device platform for synchronization, the request router 46 may route such request through the system interface generators 44, for example.

FIG. 13 is a schematic focusing on the Insight Services architecture 34. The Insight Services architecture 34 may include (but is not limited to): an information interaction layer 62, a metastructure subsystem 64, a policy subsystem 66, an audit subsystem 68, a user subsystem 70, command translation services 72, and a command interaction layer 74, for example. The information interaction layer 62 manages interaction with all data repositories 32, including resolution of information across multiple data stores and multiple data formats. The information interaction layer 62 may further include an abstracts repository storage format from higher level services.

Still referring to FIG. 13, the metastructural subsystem 64, policy subsystem 66, audit subsystem 68, and user subsystem 70 are interrelated subsystems. Each of these subsystems has a series of storage structures (e.g., relational database tables) and a series of core logic algorithms built on top of them. The metastructural subsystem 64 may be a series of storage structures and a subsystem kernel that sits on top of them. This gives the system powerful self-generating and self-descriptive capabilities, as well as extreme data schema flexibility and robustness. The subsystem tables provide a class-based, object-oriented description of the logical and physical composition of the entity relationship model with which the system may interact. Most existing databases are rigid and brittle in nature, in that additions, deletions, and/or customizations are potentially problematic to implement, come with performance and maintainability costs, and in some cases are altogether impossible. The first embodiment of the present invention provides the ability to accept changes and morph itself to accommodate such changes with much less effort and much faster.

The metastructural subsystem 64 is designed to accommodate data schema changes of even the most extreme scale and implement them extraordinarily rapidly. Alterations in the entity relationship model ranging from the addition of a single field or index to a complete redesign of the entire user data model may be accomplished by changing the values in the subsystem tables and requesting that the subsystem kernel re-synchronize the data schema to its understood definition. This capability enables the database to self-generate in a matter of seconds, even for a data schema of hundreds of logical classes (e.g., tables in a relational database context) or more. This same synchronization process may be performed automatedly at set intervals to insure data model integrity, causing the database to be self-repairing as well. The metastructural subsystem 64 also may store logical and relational structure information far beyond what is necessary to create the physical data model to provide self-descriptiveness. The flexibility of the metastructural subsystem's design and deep integration into the fabric of the system allow configuration of a system instance from within that same system instance, even while the instance is running and users are logged in. This dynamic configurability functionality allows for changes to be made to the application without having to shut down the application for hours or days at a time—a prospect that can be frustrating to customers attempting to maintain the fluidity of day-to-day operations.

Still referring to FIG. 13, the metastructural subsystem 64 may include heterogeneous information management 76, descriptive services 78, and synchronization services 80, for example. Heterogeneous information management 76 manages connections to all data repositories 32, including location and storage format information. Descriptive services 78 provides extensive meta-information management for all object classes. Also, descriptive services 78 provides on-demand, dynamic schema generation for object classes, class members, and object class interrelations. Synchronization services 80 analyzes storage structure of data store in relation to the current information model's meta-information and alters the data store's structure where necessary to ensure that the two are synchronized. These same services may be used to repair damaged or corrupted data stores as well.

The policy subsystem 66 may include authentication services 82 and authorization services 84, for example. Authentication services 82 may be used to authenticate users and foreign systems by passed credentials. Authorization services 84 may be used to examine authenticated users' and systems' access privileges on system resources.

The policy subsystem 66 controls access privileges to system resources including user interfaces and insights. A user interface includes the presentation of specific data rendered on a screen for viewing specific information (e.g., graphical user interfaces as shown in FIGS. 1-10). Certain users may have access to certain user interfaces while others may not. For example, a field supervisor may have read-only access to historical well data, whereas his subordinates may not have such access. Likewise, certain users may have access to certain insights while others may not. For example, management may want to allow certain administrators the ability to input and/or view daily job data, but they may want to block these same administrators access rights to sensitive corporate areas such as human resources or personnel files. Access privileges may be specified with more granularity as well. For instance, one user may have full access to an insight while another might be able to only view the insight, but not alter data. Additionally, some users may have delete privileges for an insight while others do not, and likewise for the creation of new record objects.

The policy subsystem 66 may keep an inventory of all insights and user interfaces that are registered with the system to provide resource awareness. Such inventory allows an administrator or superuser to easily administer policies of his/her choosing based on comprehensive detail of the configuration and mechanisms through which to interact with the system. For example, there may be 50 insights in the system, but the primary administrator may want to define three distinct user groups: operational, management, and viewing. Operational users may have abilities to input and view data in ten specific insights categories. Alternatively, it is a simple process to give one of these operational users access to other insights within the system as defined by the primary administrator. For group-based privilege administration, access privileges are not assigned directly to an individual user, but rather to a user group for ease of administration. A user may be a member of multiple groups and a group may have multiple users. Each group has specified access privileges to whichever system resources the administrator or superuser deems appropriate.

The audit subsystem 68 may include logging services 86, usage analytics 88, and rollback services 90, for example. Logging services 86 may be used to log interaction with the system, including information changes, non-destructive queries, and resource usage. Usage analytics 88 may be used to provide information about how system resources are utilized based on logged information. Rollback services 90 may allow rollback of object attribute values and “undelete” functionality.

The audit subsystem 68 may encompass functionality for logging each distinct change that has been made to a record object. Audit subsystem history may be used to view an update-by-update history of a record object since its creation to provide a detailed history of information. This information may also be used to roll back changes if a user has privileges to do so. The audit subsystem 68 may also keep a detailed record of user activity including record creation and alteration, authentication, navigation, resources requested, and resource utilization to provide user activity logging.

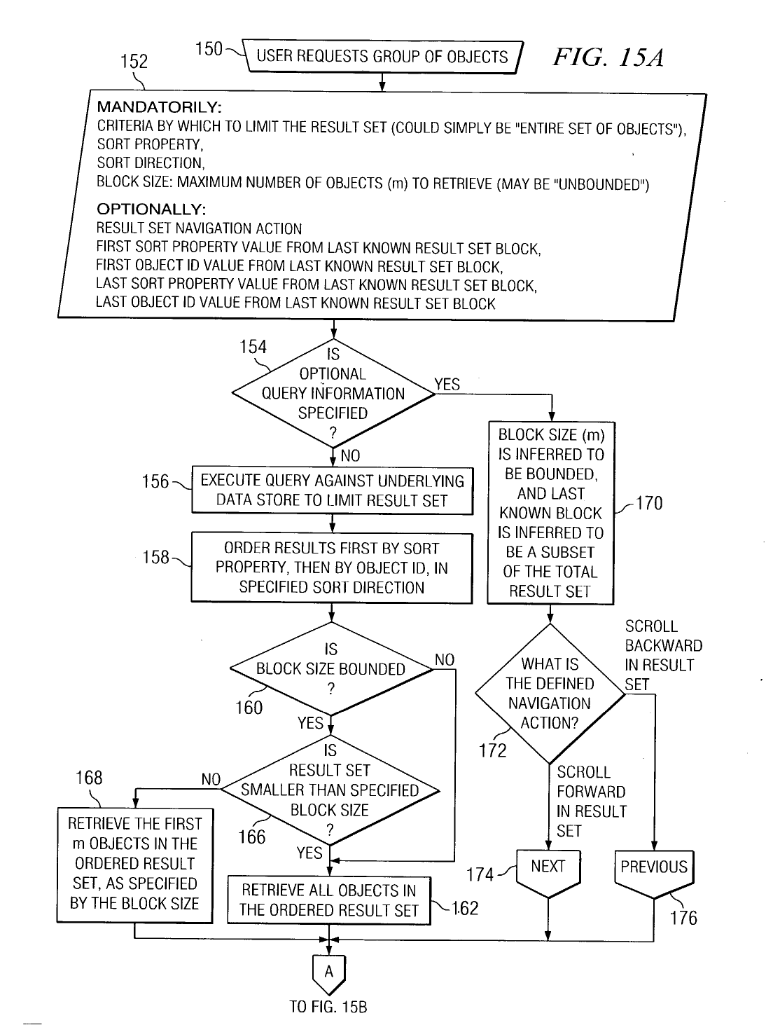

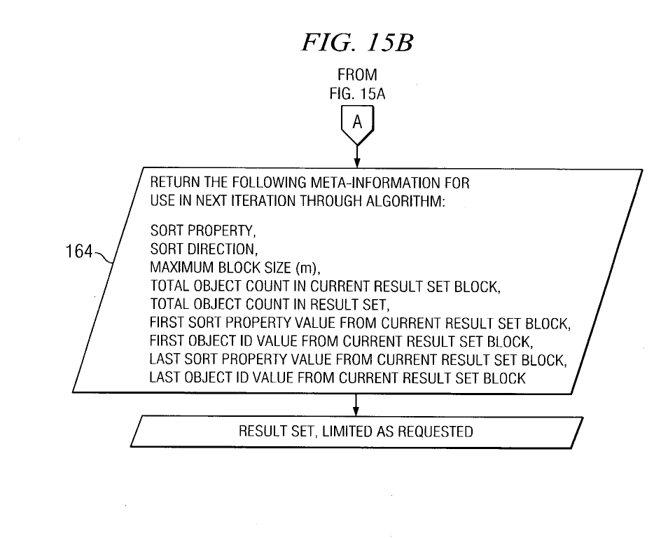

The user subsystem 70 may include objectset resolution and assembly 92 and stateless cursor functions 94, for example. The objectset resolution and assembly function 92 may be used to resolve and generate objectsets according to passed command information, descriptive and resolution information generated by the metastructural subsystem, and objectset data returned from the information interaction layer (discussed below). The Stateless Cursor Algorithm 94 enables objectset cursor functionality without client sessions or persistent server-side resource consumption, which will be discussed in more detail below with respect to FIGS. 15-17. The user subsystem 70 forms the main body of knowledge that the system portrays to the user and with which the user interacts. Parts of the user subsystem 70 are structured in the tradition of conventional database design and are fully normalized. Well-known techniques for optimizing performance such as single column indexes and primary key joins may be applied throughout the user subsystem table structure to provide optimization. The user subsystem 70 may interrelate with other subsystems transparently as though their comprising objects belonged to the user subsystem as well. The user subsystem 70 is generated by the metastructural subsystem 64.

The command translation services 72 may be used to translate commands, tag commands with corresponding meta-information, and route commands among subsystems in the Insight Services core. The command interaction layer 74 may be used to accept and validate command interface requests. If such requests are valid, the command interaction layer 74 passes control to the command translation services 72. Also, the command interaction layer 74 may be used to maintain system-level process logging. The command interaction layer 74 may be further used to return all serviced information, including objectsets, schemata, prototypes, information model diagrams, and process logs, to the calling process.

Two factors may limit the ability to provide information on a user's system 40. The first is the amount of memory on the user's system 40. Although the user may want to have or use more search results at a given time, it is undesirable to overload and lock-up or crash the user's system 40. The second limiting factor is connection speed or bandwidth available between the user's system 40 and the remote system server 38. Because many of the users may be people on the road or working in the field, many of the users may be connecting to the system server from a conventional telephone line in a hotel room using a dial-up modem (e.g., 28.8 modem connection) or from a wireless connection using a hand-held device. Also, many of the clients may be using a laptop computer or a hand-held device with limited memory resources and limited computing power. In such cases, the amount of data transferred between the client 40 and the server 38 becomes a precious commodity. Hence, in such cases, it is desirable to limit the amount of information sent to what is needed at a given time. Then if more information is needed, it may be requested. If a user is working from a powerful desktop computer connected with DSL or a T1 connection, for example, then these limiting factors may not present a problem. But as mentioned above, this is not the typical case for some types of users. Thus, one of the advantages of the first embodiment is that the system minimizes the amount of data transferred to the client while still providing adequate information and functionality at the user end. There are two core methods that the first embodiment incorporates to accomplish such minimization: Dynamic Thin Client architecture and Stateless Cursor Algorithm. The combined use of these two methods in concert provides a powerful software tool, but in other embodiments each may be used independently and without the other. A more detailed description of each of these core architectural features follows.

### Dynamic Thin Client Architecture

The Dynamic Thin Client architecture in accordance with the present invention is shown in FIGS. 14A and 14B. With the Dynamic Thin Client architecture, the user 40 is not required to permanently load a specialized or dedicated software program onto the his or her computer 40 for providing the graphical user interface services for accessing and managing information. Instead, the functionality required to provided a robust, feature-rich user-interactive experience is dynamically loaded in memory on the user's computer 40 when the user first signs onto the system, and is then run in the context of a standard web browser. Hence, the only software needed by the client 40 is a standard browser application (e.g., Microsoft's Internet Explorer, Netscape Communicator). When a user first goes to a URL corresponding the location of the system server 38, the system server 38 sends a group of static libraries and dynamically generated libraries to the user's computer 40 via a communication line 96 using a wire protocol (e.g., http, https). The server 38 generates the code in a scripting language, for example, which has the libraries therein. FIG. 14A is a diagram showing a high-level overview of the general architecture for the Dynamic Thin Client. FIG. 14B is an implementation of the general architecture shown in FIG. 14A, in accordance with the first embodiment.

Referring to 14A, the general architecture of the Dynamic Thin Client will be described first. In FIG. 14A, two boxes are shown; one labeled system server 38 and the other labeled client browser 40. The two boxes are separated by two way arrow 96, which represents communication using a wire protocol. The wire protocol is any communication protocol for network communication (e.g., back and forth asynchronously) across any communication medium (e.g., wire, fiber-optic, wireless, satellite, etc.), or local communication which takes the form of network communication. In the current preferred case, using the Internet, the wire protocol may be HTTPS or HTTP.

The system server box 38 is not intended to denote a physical machine but rather a logical collection of system components and processes, which may be centrally located and/or located across a geographically disperse network. For instance, one of the data stores may be in a customer's data warehouse or repository center in Houston and another one could be a set of flat files in somebody's workstation in a Chicago office. And some of the system's services even could be running off of servers in New York while others technically could be running off of servers in Tokyo. As long as the components can communicate with each other, the physical location of the system server components is not relevant (assuming from a pragmatic standpoint that there is enough bandwidth between them). How system server components talk to each other, where they are located, and how long it takes them to communicate with each other is certainly an implementation consideration, but architecturally there is nothing restricting the physical location or mode of connection of these components.

Component 100 labeled “Data store(s) and process(es) to get the data” is an abstraction to a lower level of the system that handles data interface. For example, component 100 may be a legacy database system where the data is stored. The static libraries 102 provide generic or universal functions for repeated tasks that are independent of the information requested. Static libraries 102 have a degree of reusability of functionality on the client 40 for doing a lot of the same types of things in interacting with information regardless of the manifestation of that information. Static libraries 102 are static in the sense that they are simply pulled off of a disk or pulled out of the database or pulled out of some sort of storage mechanism and then sent down to the client 40 as is. The static libraries 102 are not libraries that run on the system server 38, rather they are libraries that are passed down to the client 40 and then run on the client 40.

As the label suggests, component 104 represents a process (or processes) to translate information from a data store (or data stores) 100 into a denser, more compact format (serialization) and to resolve logic that is information specific to a requested result set. Component 104 interacts with the data services on a lower level of the system (component 100). Component 104 also translates the information received from component 100 into a form that can be sent across the wire protocol 96, which is the serialization of the information. Preferably, but not requisitely, component 104 translates that information into a dense, efficient format that requires a minimum of bandwidth during transmission. The serialization may output a serially opposed binary stream of some sort (e.g., a stream of characters representing string arrays, or simple XML). Preferably, serialization provides an output that is highly normalized and compressed using optimized algorithms for these purposes. Because the information at the data store level 100 is almost always stored and organized as objects, it is preferable to serialize the information in the form of dense, but interpretable object constructors for transmission. Note, however, that it is not necessary to condense the data for this architecture. The server 38 could just send a lot of verbose XML, or something like that, to the client 40, but that would require a lot of bandwidth and would be much slower both due to the increased transmission size and a potentially more processor-intensive client-side reassembly of the information in memory (e.g. a browser-based XML DOM implementation, etc.). Beyond serialization, the process(es) of component 104 also resolve the logic needed to communicate the construction of the serialized information after it arrives at the client 40. The server 38 passes down this functionality needed by the client 40 for reconstructing the serialized data before the server 38 sends the condensed data to the client 40. Then, when the client 40 receives the condensed data, it can reconstruct it in a meaningful way.

In a broader sense, all of the static libraries 102 may be sent down to the client 40. But in a more sophisticated embodiment (and preferably for optimization), there is interaction (arrow 106) between the component 104 and the static libraries 102. Only the static libraries 102 needed based on the client request are obtained and sent with the information generated by component 104. Hence, component 104 only grabs the static libraries 102 needed in order to minimize the size of the static libraries sent down to the client 40. Again, one of the goals of an optimized system using this architecture is to minimize the size of the information sent between the server 38 and the client 40 with each communication.

Component 108 in FIG. 14A includes a process (or processes) for interacting with the client 40. Note that on the client browser side 40, there is a corresponding component 110, discussed further below, that “shakes hands” with component 108 so that the server 38 and the client 40 have a way of communicating in a common language. Components 108 and 110 coordinate the communication and transfers back and forth between the server 38 and the client browser 40. Thus, everything coming from the static libraries 102 and component 104 passes through component 108 to 110 in the process of code and data transmission from the server 38 to the client 40. The communication between components 108 and 110 may be as basic as receiving a request, passing along the request to the appropriate components, and sending the response to fulfill the request.

Another goal of the Dynamic Thin Client architecture is to provide the functionality at the client browser 40 to reconstruct, robustly interact with, and meaningfully display the information to the user without requiring synchronous communication with server-side components, or frequent round trips to the server 38 with the expectation that the server be responsible for providing the bulk of application functionality. In other words, after the dynamic and static libraries, along with the condensed information, are sent down to the client browser 40 from the server 38, the communication 96 between the server 38 and the client 40 can be discontinued prior to running the code on the client browser 40 to provide a graphical user interface for the user. Thus, the logic contained in the client 40 operates independent from the logic that operates in the server 38, and they “shake hands” via components 108 and 110 only when necessary.

Referring now to the client browser 40 in FIG. 14A, component 110 provides a process (or processes) for communicating user actions to the system server 38. Component 110 also interprets response results sent to the client 38 from the server 40 and provides process(es) for reassembling and reconstructing the information in a meaningful way at the client browser 38. Component 112 provides processes for running code sent down from the server 38 on the client browser 40 to interact with the information passed down to the client browser 40 by the server 38. Component 112 includes: 1. Logical interaction and 2. User interface and interaction.

Logical interaction (in component 112) is primarily from the static libraries 102, which includes functions such as validation, record creation, record updating, and other functions, for example. For instance, the function of creating a record will typically be the same every time, regardless of the property type, and hence it would likely come from the static libraries 102. Validation of data entered as a property value, however, will usually differ somewhat each time for different record types or property types (e.g., phone numbers, employee number, social security number fields), and hence it will likely be a library that was dynamically generated by component 104 at the server 38.

User interface and interaction (in component 112 also) is similar each time it is run because the graphical user interface displayed on the browser to the user will have a similar structure and form each time, and thus will likely come from the static libraries 102. However, the fields and properties to be displayed, how they are displayed, and in what order they are displayed, will be somewhat dynamic based on the information specific to the request, and hence will likely come from a dynamically generated library generated by component 104. Therefore, a combination of the static library and dynamic library functions work in concert to provide the logical and graphical user interactions with the information of the query results.

The Dynamic Thin Client architecture provides several advantages. One advantage is that the optimization algorithms in the serialization process in the server 38 provide the ability to interact with the server 38 remotely over the Internet and over even a low bandwidth connection. Although architecturally the serialization process is optional, it only makes sense to make use of it because of its advantages in making the data transmitted more dense and compact. Another advantage of the Dynamic Thin Client architecture is the user's experience of interacting with the information over the Internet. Although there are a lot of web-based applications today, one of the things that is lacking in current web-based applications is that there are very few that can compete in functionality with a desktop application. A user might log on to an online shopping site, for example, and point and click to choose items. The user may choose six of the items for quantity, the price may be calculated, and the user's credit card information is often taken and processed. But in terms of user interaction, it is a relatively a small amount of user interaction and it is often not very sophisticated in terms of user experience. There may be a lot going on under the hood (on the server side) but the user's experience is really fairly basic. But in providing a user experience more comparable to something the user would typically find on a desktop (e.g., Outlook email software, Excel spreadsheet software, etc.) and that is running in a browser with downloaded code that does not remain permanently installed on the user's machine (i.e., gone after the browser is closed), the user's experience in a web-based application is enhanced and richer. A lot of the same user interface metaphors that most people are comfortable with in Microsoft Office or another similar product suite that appears on just about everybody's desktop may be found in the application that runs on the client browser 40 using the Dynamic Thin Client architecture. Peripherally related to the prior mentioned advantage and also fairly important architecturally is a benefit that any updates or patches to the application are propagated to the clients automatically. It doesn't matter if there is one client on the system or if there are 100,000 clients using the system, an update can be made to the server and the next time a user logs on to the system, all of the updates (whether its additional functionality or patches or whatever it might be) are automatically propagated down to that client 40. Hence, the system management overhead incurred by a lot of other systems disappears. It is no longer a critical factor in deciding whether you can deploy this system to people. Most personal computer systems today include an Internet browser already loaded right out of the box. Really the only deciding factor is whether the system provides a business benefit and whether the people can be trained to use it. Once those hurdles are past, anybody can use it from anywhere without the need to permanently load software (e.g., via CD or DVD) to each user's machine.

FIG. 14B is an implementation of the Dynamic Thin Client architecture shown more generally in FIG. 14A. FIG. 14B fits in with the first embodiment of the present invention. Beginning with the system server portion 38, data stores (1 through n) 120 are shown to illustrate that there may be one or numerous different data stores 120 of the same or different types and at the same or different physical locations. As discussed above regarding FIG. 13, the insight services 34 provides the ability to communicate with and access the data store(s) 120. The insight services 34 handles all direct interactions with the data store(s) 120. The insight services 34 is especially useful when there are many different types of data stores 120, each with its own interface protocols and storage methods.

The interface generator 122 provides the ability to create libraries dynamically (as needed). The interface generator 122 also handles interaction across the communication line from the client 40 in a way that is communicative to the insight services 34 of the user's intentions. The interface generator 122 translates information from the user's request into a format that is usable by insight services 34. So for example if the user is requesting that information be updated, the translation of the user's request happens first on the client side 40, then through the interface generator 122 on the server side 38, and is then passed on to the insight services 34 such that each component understands that the others' functions have been carried out, but does not concern itself with how the other components operate. The interface generator 122 may be implemented in several different ways and in the manifestation of several different components.

As shown in FIG. 14B, the interface generator 122 may contain various types of dynamic library generators 124. The dynamic libraries do not actually exist until something is requested from the insight services 34 and then, based on meta-information that is passed back from that request, the dynamic libraries needed are generated. The dynamic libraries may be for functions such as dynamic process specific and schema specific logic generation, which may be something like validation or trigger based activity, for example.

One type of dynamic library generator 124 may be needed for environmental concerns. If there are different versions of the client libraries for different browsers (e.g., Internet Explorer, Netscape, Opera), each browser supported may need slightly different user interface generation libraries. Hence, the environmental dynamic library generator could send down the correct version of the libraries generated, based on the client environment. Another type of dynamic library generator 124 is information based. The information based dynamic library generator provides process specific logic and schema specific logic. The environmental and information based dynamic library generators both effectively take inputs and generate functions or pull functions from a library store as needed. In the environmental-based type, the inputs may be coming to the server 38 from the client side 40 providing information about the client 40. In the information-based type, the inputs may be information coming from a lower level of the system from the insight services 34 and the data that was pulled into the response string based on the request sent to insight server 34.

The interface generator 122, in concert with the static libraries 102, generates a user interface for use and to be run on the client browser 40. In the implementation of the first embodiment shown in FIG. 14B, everything sent from the server 38 to the client 40 is sent in the form of script code (e.g., JavaScript). The use of scripts is an implementation consideration, not an architectural one. If a browser becomes readily available and used that is smart enough to implement logic by virtue of meta-information, then an implementation could take advantage of that and send meta-information. To date, the preferred implementation is to send everything to the browser in the form of JavaScript code because nearly all browsers can understand and run them.

As an example, the script sent down to the client may have logic for calculating prices based on line items in an order. The prices for the individual items may vary depending on factors such as quantity, discounts, country, and/or customer. Thus the price information may not be stored with the item information that remains constant (e.g., item name, item description, etc.). Hence, all of the factors for price combined, using the logic provided, generates a price for that line item. In some systems, such calculations are performed on the server end. But with the first embodiment, because the interface generator has sent the logic down to the client browser 40 for running on the client browser 40, all of such logic and calculations are performed at the client 40. The logic is stored in the database as meta-information. The interface generator 122 converts the meta-information into scripts that can run on the client browser 40. Thus, when the user inputs information (e.g., selects an item) on the client browser 40, the running script automatically calculates the price without assistance from the server 38. Or, if a quantity is changed, the price is automatically updated by the client browser 40, for example. The browser itself does not know how to calculate the price, it is simply told, “run this script when this condition is met.” The browser does know how to run a script, however, and the logic (originating from meta-information at the server, converted to script) tells the browser what action to take and on which information.

As another example, various fields preferably need to be validated before they are sent to the server 38 and considered valid for entry back into a data store 120. Properties with fixed sizes, for example, such as social security numbers, U.S. telephone numbers, and dates, are preferably validated. Hence, a dynamic library generator 124 converts meta-information about a property that can be validated into logic that can run on the client 40 (e.g., JavaScript). Then the client 40 is not just blindly or ignorantly allowing a user to input wrong information into a field on the graphical user interface. A dynamic library generator 124 may also convert meta-information (e.g., what the information is, how the information is related, how the information needs to be used) from the meta-structure to a runnable logic that is run on the client browser 40 so that the client browser 40 becomes intelligent and cognizant of what information is and how it needs to be dealt with.

The static libraries 102 are implemented exactly as was described above regarding FIG. 14A. Component 126 labeled “Serialization/Deserialization and Reconstruction” in FIG. 14B is an implementation of the component 108 labeled “Process(es) for interacting with client” in FIG. 14A. Component 126 takes information sent from the insight services 34 (a response to a request for information from the data store(s) 120) to the interface generator 124 and serializes it to a denser format for transfer. Then component 126 sends the serialized information over the communication line using a wire protocol to the client 40 so that the client can reconstruct it. Component 126 also takes individual libraries that have been generated (by the dynamic library generator 124) or pulled from some resource on the server or data store(s) (static libraries) and it serializes these libraries for sending down to the client 40 over the wire protocol. The serialization process may be as simple as pulling a file off of a disk and sending it down to the client 40 or it may be considerably more complex. Also, when a request is received by the server 38 from a client 40, it passes through component 126 for deserialization and reconstruction on the server side 38. Hence, when component 126 is used in an operational interface role, a request is passed through component 126 to the insight services 34 by using the logic contained in the interface generator 122.

Referring now to the client browser side 40 in FIG. 14B. Component 128 is labeled “System-Level Logic,” which includes logic sent down from the static libraries 102, as well as logic sent down from the dynamic library generators 124. Within component 128 are component 130 labeled “Construction/Deconstruction and Reserialization” and component 132 labeled “Insight-Level Logic.” The counterpart of component 126 in the architecture is component 130. Component 130 is an implementation of component 110 in FIG. 14A. Thus, component 126 shakes hands with and communicates with component 130. Component 130 is a set of libraries used to translate the information, schema information, and meta-information into object form instantiated on the client 40 such that the user can interact with it. The responses sent down to the client browser 40 from the system server 38 are received by and processed by component 130. Component 130 deserializes and reconstructs the response from the server in a meaningful way to the client browser 40 so that the user who is actually interfacing with the response on the client 40 can interact with the information as if the user is logged on to a session on a server and interacting using the server logic (old way), except that the user is not. What has actually happened is that the client 40 has received an asynchronous data set that is translated and stored in memory at the client 40 so the user can interact with the information using logic that is all contained on and run on the client browser side 40. Such objects have functions and properties that provide robust interaction capabilities for the user on the client browser 40 without interacting with the server at all to provide such functions and properties. Such functions and properties may include calling a method, adding an object, copying an object, and deleting an object, for example. The user can submit any changes to the information or add new information to the data store(s) 120. The system server 38 receives the information sent from the client 40 and passes it on to the insight services 34 after translating it as needed. The insight services 34 then sends the updated or added information into the data store(s) 120 for storage.

Insight level logic provided in component 132 is mostly logic passed down from a dynamic process specific and schema specific logic generator 124 of the interface generator 122. Such logic is specific to the information contained at a particular insight. Optionally, there may be additional sub-insight-level logic (component 134) embedded within component 132. Hence, insight level logic 132 is recursive and may have multiple levels of logically related sub-insight logic 134. Sub-insight-level logic 134 may be used for more information provided within an insight to allow a user to drill down deeper into information values comprising subsets of related information.

Arrow 136 shows that the system level logic 128 is relates to the insight level logic 132, and vice versa. An example of this relationship is that the schema information in the insight level logic 132, e.g., for an Account insight (as in FIG. 1), may interact with system level logic 128, e.g., create a new object. Functions or processes that are universal or generic like how to create a new object, how to delete and object, how to update an object, or how to resolve information generally among objects, for example, may be loaded as system level logic 128 once, e.g., the first time the user logs on to the system. Then, functions and processes specific only to the information that the user is viewing at any particular point in time can be loaded into the insight level logic layer 132 within the client browser 40. Such functions and processes that are specific to one particular request may be instantiated for the life of that request while the user is looking at that information, and then they can be deleted from memory at the client 40 so that the client's memory may be freed up as soon as the user is no longer looking at that information. System level logic 128, on the other hand, has functions and processes that are fairly generic and universal to any requests by the user. This enables the system level logic 128 to exist at a higher level than the insight level logic 132. With the system level logic 128 loaded at a higher level and persisting across client requests, a system using this architecture can be more efficient because the client 40 does not have to reload redundant information that will be reused. Thus, arrow 96A represents the loading of the static libraries 102 into the system level logic 128 one time when the user first logs onto the system.

Arrow 138 represents a relationship between system level logic 128 and the one or more optional sub-insight level logic(s) 134. Hence, arrow 138 is exactly as arrow 136 in terms of the relationships involved. As an example of the concept of a sub-insight level logic 134 within an insight level logic 132, consider the example screen shot shown in FIG. 1. Within the Account insight (left frame of FIG. 1), there are four sub-insights: Addresses, Contacts, Properties, and Jobs. If a user wants to drill deeper for more information about an account, such as viewing all addresses for a particular account, the user may call upon the Addresses sub-insight within Accounts after selecting (highlighting) a particular account object. There may be only one address or there may be sixteen addresses, for example. Now if the user wants to add a new address for that account, the address insight, which is currently playing the role of a sub-insight, can interact with the system level logic 128 for the generic process of adding a new address. Because adding a new value for an address insight may be the same process as adding a new value for any other insight, it is more efficient to tap directly into the system level logic 128 for a generic process, as such.

Arrow 140 represents the relationship between insight level logic 132 and optional sub-insight level logic 134. As in the previous example, the address for each account can be linked through the relationship of the sub-insight with the insight.

Relating the implementation of the client browser 40 shown in FIG. 14B back to the client browser 40 shown in FIG. 14A, the user interface portion in component 112 of FIG. 14A is implemented in the system level logic 128 of FIG. 14B. The logical interaction portion in component 112 of FIG. 14A is implemented both in the system level logic 128 and the insight level logic 132 of FIG. 14B. For example, processes like creating a new record or deleting a record will likely be in system level logic 128. Whereas, the fact that an Account insight in this example (see FIG. 1) has the properties of name, tax ID, main phone number, and main fax number associated with it is specific to a schema setup and to a particular class of objects, and thus will likely be in the insight level logic 132.

Regarding arrows 96A-96C connecting between the system server 38 and the client browser 40 in FIG. 14B, these arrows represent the communication between the server 38 and the client 40 using a wire protocol. As mentioned above, arrow 96A represents all of the system level logic 128 being loaded (mostly from the static libraries 102) once at the beginning when the user first logs on to the system. The functions and processes in the system level logic 128 are used to format and instantiate all the information passed down from the server 38 to the client 40 in subsequent requests. Arrows 96B and 96C represent subsequent communications for subsequent requests. Arrows 96B and 96C essentially represent the same communication because a sub-insight is just an insight within an insight. Hence, arrow 96C is for a request relating to a sub-insight and arrow 96B is a request relating to an insight. The requests and responses across arrows 96B and 96C pass through component 130 for deconstruction and serialization (sending to system server 38) or deserializing and reconstructing (for receiving from the system server 38). Component 130 in FIG. 14B is an implementation of component 110 in FIG. 14A.

Arrows 96A-96C do not necessarily represent separate communication lines, but rather different possible routes for different possible times over the communication line 96. For most cases, the wire protocol used over the communication line 96 will be the same type of communication that facilitates interaction among web clients and web servers. The architecture of the communication is stateless and sessionless, as will be discussed further below regarding the Stateless Cursor Algorithm.

### Stateless Cursor Algorithm

The Stateless Cursor Algorithm is shown in FIGS. 15-17. The Stateless Cursor Algorithm of the first embodiment provides a way to reassemble the information gathered from a certain query on the server end based on a small amount of information sent up to the server from the client so that the system is state preservative, but without actually keeping a session open on the server and without maintaining state on the server end. Hence, after a user obtains information requested from a query, the server can immediately free up those resources used for that request to service the next request from any other user. When the client makes a request, the server reassembles the client's current query and knows with which subset of the query results the client is currently working (e.g., viewing items 51-70 of 390 resulting items) using eight criteria sent up to the server from the client and the Stateless Cursor Algorithm.

FIGS. 15-17 are flowcharts showing the Stateless Cursor Algorithm of the first embodiment, which is a case where only one sort property is used (i.e., the query results are sorted according to only one property). The case of a single sort property is shown to simplify the discussion and explanation of the Stateless Cursor Algorithm concepts. In other embodiments (not shown), the query results may be sorted by two or more properties. For example, the query results may first be sorted by equipment in ascending alphabetical order (for equipment names), then the results may be sorted by date checked out in ascending order (i.e., earlier dates followed by later dates). Hence in such case, if there are fifteen welding machines and ten generators, then the group of fifteen welding machines will be sorted in ascending order based on date checked out and the group of ten generators will be separately sorted in ascending order based on date checked out.

Referring to FIG. 15, beginning at the top at block 150, when a user requests a group of objects (i.e., an insight) (e.g., by clicking on a button on the graphical user interface presentation provided at the user's computer), the query request information is sent up to the server from the client. The inputs needed for the Stateless Cursor Algorithm of the first embodiment are shown in block 152. The four mandatory input values include: criteria by which to limit the result set, sort property, sort direction, and block size (m). There are also five optional input values (see block 152), which include: result set navigation action; first sort property value from last known result set block; first OID value from last known result set block; last sort property value from last known result set block; and last OID value from last known result set block. The use of these input criteria will be described below while discussing the Stateless Cursor Algorithm.

The input values needed will depend on the type of query request. There two types of requests contemplated for the first embodiment, but there may be others for other embodiments: (1) requests for the first subset of the total set of objects in an objectset, and (2) requests that specify a particular subset of the total set of objects in an objectset that does not represent the beginning of the objectset. Four example scenarios illustrate the first request type (i.e., where the answer to decision block 154 in FIG. 15 is NO). A first example of the first request type is when the request is the first request by a user. For example, referring to FIG. 1, if the user clicks on Accounts in the left frame to request an Accounts insight as an initial request, the user has not specified sort property, sort direction, block size, nor any of the optional criteria shown in block 152. Hence in this case, the user has only needs to specify and pass to the server the criteria by which to limit the result set (the first criteria listed in block 152 of FIG. 15). The other mandatory input criteria in block 152 may be set by default by the system or by a system administrator, and thus made available at the server. A second example of the first request type is when the user is viewing one insight (e.g., Accounts), and then the user requests another insight that is not a sub-insight the currently viewed insight. This case is essentially the same as the first case. A third example of the first request type is when a user is viewing an insight and requests information of a sub-insight. For example, referring to FIG. I yet again, if the user is currently viewing an Accounts insight and then chooses to view an Address sub-insight for the Autry C. Stephens, Inc., then the request will yield the results shown in FIG. 4. And, a fourth example of the first request type is when the user chooses to change the sort property for a current insight being shown or to change a sort direction for a current insight being shown. In such case the client would need to send the sort property or sort direction criteria values to the server to use as inputs for the Stateless Cursor Algorithm.

An example of the second type of request is when the user requests a next or previous subset of the query result set. This would be the case where the user has already made a request, the result set is larger than the block size (m), and thus only part of the result set was sent down to the client. If the user requests the next or previous block of records of the result set, at least some of the optional criteria in block 152 of FIG. 15 will be needed as inputs to the Stateless Cursor Algorithm, as will be more apparent after the remainder of the Stateless Cursor Algorithm is described below. For example, referring again to FIG. 1, note that in this example the result set has 23 records and the block size is set to m=20. Hence, the “Next 3>>” button is provided and the user may request to see the next three records, as shown in FIG. 2.

Some of the input values shown in block 152 may be set in the system as default values set up by a system administrator, for example, and which may remain the same unless otherwise change by the user. Thus, the client may not need to specify all of the input values with a client request, depending on the type of request. An example of a criteria that may be set by the system administrator as a default is the block size (m). The block size is the maximum number of objects (m) to retrieve and send back to the user. For example, if a query returns 120 hits and the default block size is 20 records, then the server only sends down twenty records at a time to the user. Depending on the configuration at the graphical user interface, the user may have the ability to choose a different block size through setting preferences or through a pull-down menu, for example. Because different users may have different screen sizes, different memory capacities, and different communication connection speeds, the desired block size may vary for each user. The block size may be unbounded, i.e., all the query results are sent to the user.

The criteria by which to limit the result set (see block 152 in FIG. 15) may be an entire set of objects or some chosen part of the entire set of objects. Referring back to the FIG. 1 for example, if the user clicks on Accounts in the navigation panel (left frame), then the criteria by which to limit the result set will simply specify the entire set of accounts. The properties associated with accounts may be changeable by the user and/or a system administrator, and/or may be set by default in the initial set up of the criteria sets based on the business model for which the system is tailored. In FIG. 1 for example, the properties associated with accounts are operator name, tax ID number, URL, reference #, main phone, and main fax. But for another business model, users may need or desire to have a different set of the properties associated with accounts, such as mobile phone, client number, etc.

The sort property (see block 152) specifies the property by which to sort the query results. Referring again to FIG. 1 for example, the sort property chosen in this view was operator name. The sort direction (see block 152) (ascending or descending) specifies the direction of sort. Alphabetical/numerical/date/time order are implied by the system's knowledge of the data contained in values for the specified sort property. Hence in the example of FIG. 1, the query results are sorted by the sort property of operator name in ascending alphabetical order. A default sort direction (e.g., ascending) may be used so that the user does not have to concern himself/herself with specifying this information unless the initial sort does not portray the information the way the user would like. If the user wishes to change the way the objectset is sorted, (FIG. 1), the user may click on one of the sort arrows (21 or 22) next to the property names, to select a different sort direction. Similarly, the user may click on a different property name to invoke a different sort property. In both cases, the user would be submitting another request (i.e., starting at the beginning of the flow chart at block 150 again).

Referring to decision block 154 in FIG. 15, with the input information of block 152 (at least part of which may have been sent up to the server system from the client over the wire protocol), the server next determines whether the optional query information has been specified (depending on the type of request). At block 154, if the optional query information is not specified, the server system then executes a query against the underlying data store (i.e., the database) to create a result set limited by the criteria provided in the query request information (block 156). Next, the query results are put in order, first by sort property, then by the object identifiers (OIDs), in the specified sort direction (block 158).

An OID is a 34 character string assigned to each object based on a globally unique identifier (GUID). A GUID is a 32 character string that is inherently unique. For purposes of this application, two additional characters are tacked onto a GUID to create a property value called OID. A GUID is an algorithmically generated binary sequence that is guaranteed to be unique across time and space, no matter what machine you use to generate it, as long as the number GUIDs generated per second is less than a very large number (e.g., not greater than billions per second). Each object record in the database is assigned its own OID, and thus no two objects will ever have the same OID value. The OID is not a value that needs to be presented to the user, but is rather a way for the system to maintain data integrity and to have a unique identifier associated with each record. The OIDs are also used by the system to refer to other records, such as when setting up a table of association or relations among sets of objects. Thus, if there are twenty records having the same values for each property (except for the OID property), each record is still distinguishable based on its OID because each record has a globally unique identifier assigned to it. Therefore, no matter how many records are the same, as far as the user is concerned, each record has an OID value that ensures each record is unique. The OID stays with the object forever until the object is deleted from the database.

The last property that is sorted every time for a set of query results is the OID property. Using the OIDs allows for queries to be repeated and duplicated, even if many of the values for a given sort property are the same. The following example data set in Table 1 may help clarify this point:

TABLE 1

| | Equip- | Equip- | |
|---|---|---|---|
| | ment | ment | Mod- |
| OID | Type | Maker | el |
| 407a83afa53c11d69d320040335b6f1e23 | Valve | Valves, Inc. | 2160 |
| 37ffbf39a30b48d88e4149ef4b51a080d3 | Pump | Pumps, Inc. | 434 |
| 7ef26cd5784d464aa1712eb8610bccaf43 | Valve | Valves, Inc. | 2160 |
| 1d89cf94b3014531a7680d0fb7b5fc2e42 | Pump | Pumps, Inc. | 434 |
| 97c9bdff416f4fc5a15ed5a1333e37e407 | Valve | Valves, Inc. | 2160 |
| 72dd01ab906c43caab0d0c1e1c83a0bf87 | Pump | Pumps, Inc. | 434 |
| 407a83f8a53c11d69d320040335b6f1e23 | Valve | Valves, Inc. | 2160 |
| f5635250f7954b02a2ba73e332e4bfd0dz | Pump | Pumps, Inc. | 434 |
| d27436baab1e4aca831428fcf9b976c1ga | Valve | Valves, Inc. | 2160 |
| 407a83faa53c11d69d320040335b6f1e23 | Valve | Valves, Inc. | 2160 |

The data in Table 1 is shown in random order. If this set of data is sorted by the property Equipment Type in ascending order using the first embodiment, the results will be as shown in Table 2 below:

TABLE 2

| | Equip- | Equip- | |
|---|---|---|---|
| | ment | ment | Mod- |
| OID | Type | Maker | el |
| 1d89cf94b3014531a7680d0fb7b5fc2e42 | Pump | Pumps, Inc. | 434 |
| 37ffbf39a30b48d88e4149ef4b51a080d3 | Pump | Pumps, Inc. | 434 |
| 72dd01ab906c43caab0d0c1e1c83a0bf87 | Pump | Pumps, Inc. | 434 |
| f5635250f7954b02a2ba73e332e4bfd0dz | Pump | Pumps, Inc. | 434 |
| 407a83afa53c11d69d320040335b6f1e23 | Valve | Valves, Inc. | 2160 |
| 407a83f8a53c11d69d320040335b6f1e23 | Valve | Valves, Inc. | 2160 |
| 407a83faa53c11d69d320040335b6f1e23 | Valve | Valves, Inc. | 2160 |
| 7ef26cd5784d464aa1712eb8610bccaf43 | Valve | Valves, Inc. | 2160 |
| 97c9bdff416f4fc5a15ed5a1333e37e407 | Valve | Valves, Inc. | 2160 |
| d27436baab1e4aca831428fcf9b976c1ga | Valve | Valves, Inc. | 2160 |

After the query results are sorted by the property Equipment Type, the records are then sorted in ascending order by the property OID. Hence, records having like values of the sort property Equipment Type are sorted by OID. Note that the records having the value of “pump” for the Equipment Type property are identical except for the OID in this case. Likewise, records having the value “valve” for the Equipment Type property are identical except for the OID in this example.

To a user that does not see the OID property displayed, there does not appear to be any order to the like records. But, as shown in Table 2, there is a specific order to the records and each record is distinct by its OID value. In another example, the sort property is Equipment Type again, but in this example the values for the property Model vary, as shown below in Table 3:

TABLE 3

| | Equip- | Equip- | |
|---|---|---|---|
| | ment | ment | Mod- |
| OID | Type | Maker | el |
| 1d89cf94b3014531a7680d0fb7b5fc2e42 | Pump | Pumps, Inc. | 434 |
| 37ffbf39a30b48d88e4149ef4b51a080d3 | Pump | Pumps, Inc. | 455 |
| 72dd01ab906c43caab0d0c1e1c83a0bf87 | Pump | Pumps, Inc. | 324 |
| f5635250f7954b02a2ba73e332e4bfd0dz | Pump | Pumps, Inc. | 34 |
| 407a83afa53c11d69d320040335b6f1e23 | Valve | Valves, Inc. | 5342 |
| 407a83f8a53c11d69d320040335b6f1e23 | Valve | Valves, Inc. | 5342 |
| 407a83faa53c11d69d320040335b6f1e23 | Valve | Valves, Inc. | 2160 |
| 7ef26cd5784d464aa1712eb8610bccaf43 | Valve | Valves, Inc. | 4426 |
| 97c9bdff416f4fc5a15ed5a1333e37e407 | Valve | Valves, Inc. | 2170 |
| d27436baab1e4aca831428fcf9b976c1ga | Valve | Valves, Inc. | 2190 |

Even though it may appear that the records having a like value for the property Equipment Type are not in any order, they are actually in a specific order based on the OID sort. Because every OID is unique, there are no like OIDs. Thus, having the set of records sorted lastly by the OID property ensures that there is a specific and known order to the records, no matter how many repeated or like values there are for the other properties. As will be discussed further below, knowing the specific order of every set of records from a query result becomes important when trying to determine what the next value will be for a next or previous group or block of records in the query results. For example, if the block size is set to 5 and the data shown in Table 3 are the results of a search query, then the last record sent to the user would be:

| | | | |
|---|---|---|---|
| 407a83afa53c11d69d320040335b6f1e23 | Valve | Valves, Inc. | 5342 |

Then the first value for the next set of records sent to the user when the user requests the next group of records would be:

| | | | |
|---|---|---|---|
| 407a83f8a53c11d69d320040335b6f1e23 | Valve | Valves, Inc. | 5342 |

Note that the only difference in these two records is the OID value. Hence, the OID value can be used to distinguish the two records.

Referring again to FIG. 15 at block 160, it is next determined whether the block size is bounded. If the block size is not bounded, then the server retrieves all objects in the ordered result set from the database for sending to the user (block 162). Then, see block 164, the following meta-information is returned to the client (as outputs from the Stateless Cursor Algorithm) for use in the next iteration through the algorithm if the user makes another request relating to the same query results: sort property, sort direction, maximum block size (m), total object count in current result set block, total object count in result set, first sort property value from current result set block, first OID value from current result set block, last sort property value from current result set block, and last OID value from current result set block. These output values from block 164 correspond to the input criteria of block 152. If the client has made a prior request and the client is storing the output values of block 164 from the prior query result block and the user makes another request wherein the output values of block 164 are relevant, then the client sends the values from block 164 to the server for providing the input criteria (block 152) for the next request. The relevance and use of these output values returned (block 164) will become more apparent after going through other portions of the Stateless Cursor Algorithm of FIGS. 15-17.

Referring back to block 160 in FIG. 15, if the block size (m) is bounded, then it is next determined whether the query result set is smaller than the specified block size (m) (block 166). If the result set is smaller than the specified block size, then the server retrieves all of the objects in the ordered result set from the database for sending to the user (block 162). Then, the meta-information listed in block 164 is output and returned to the client for use in the next iteration. If the result set is not smaller than the specified block size (m) (see block 166), then the server retrieves the first m number of objects (based on block size (m)) in the ordered result set for sending to the user (block 168).

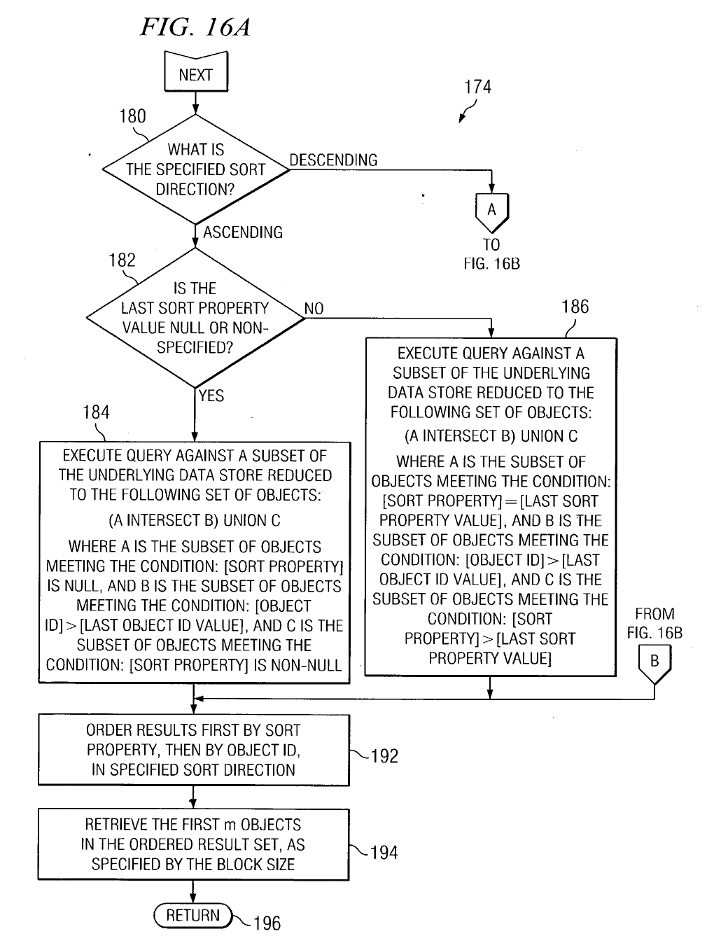

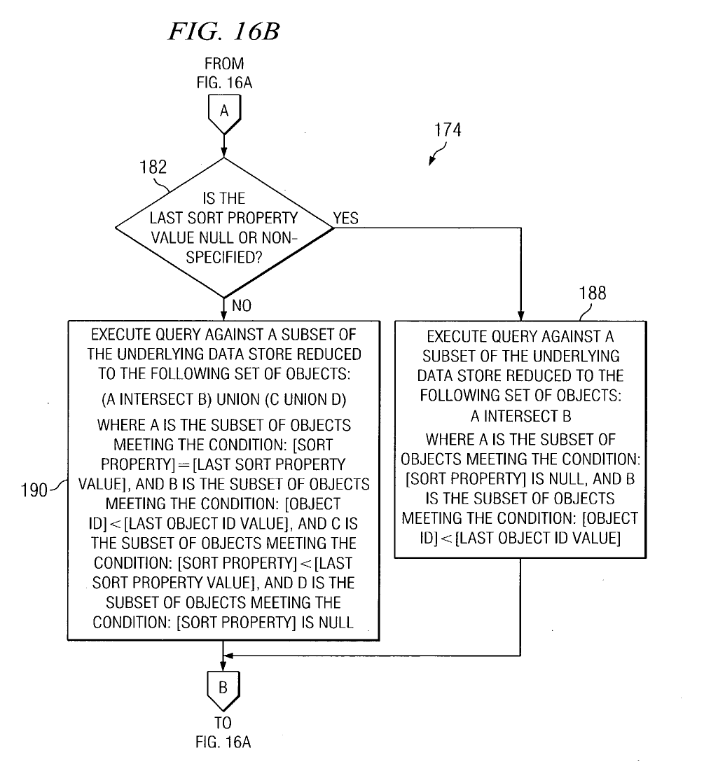

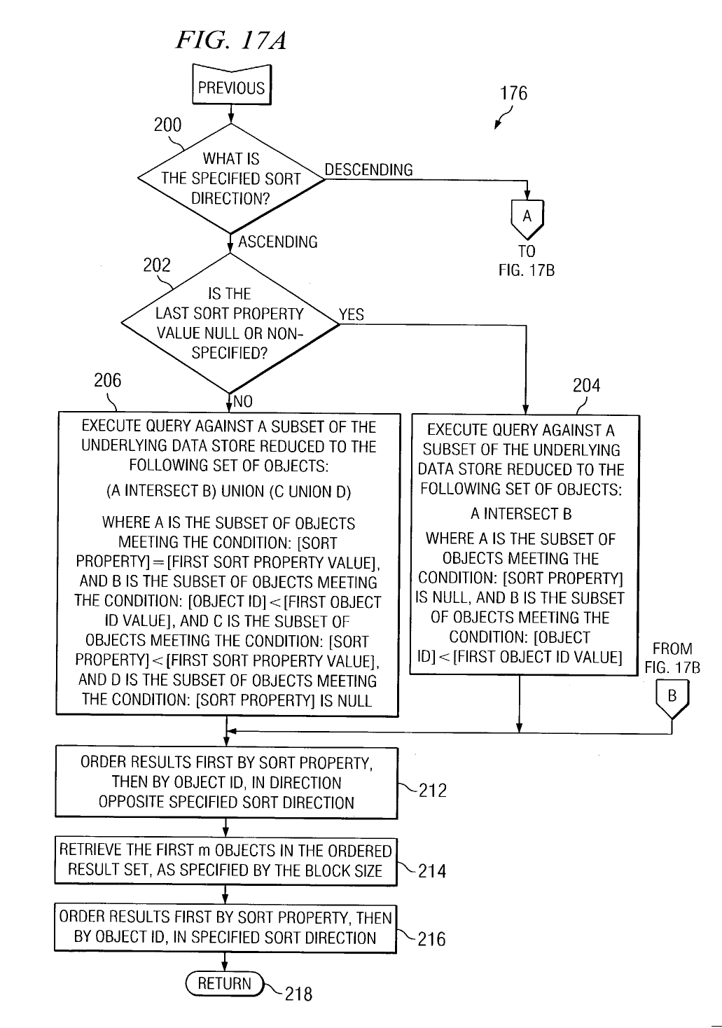

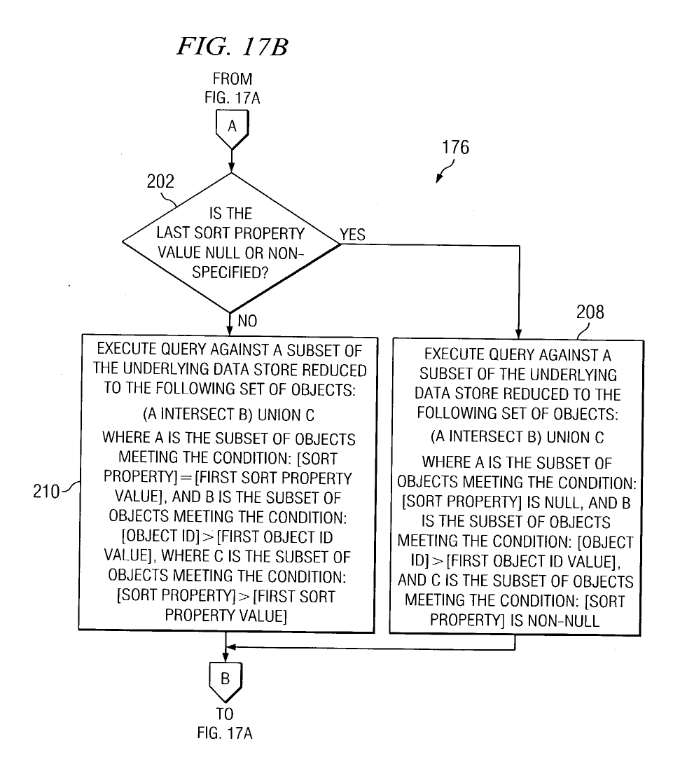

If in the user request (block 150) and the optional criteria are provided (block 152) (e.g., from a prior iteration through the Stateless Cursor Algorithm, block 164), as determined at block 154, then the block size (m) is inferred to be bounded and the last known block is inferred to be a subset of the total result set (see block 170). Hence, if the client has set the block size (m), it is assumed that the client wants to continue with the same block size, unless otherwise specified. Next, it is determined what the defined navigation action is by the user (from the user request) (see block 172). If the user request indicates that the user desires to scroll forward in the result set, then the Next function 174 is called, which is shown in FIG. 16. If the user request indicates that the user desires to scroll backward in the result set, then the Previous function 176 is called, which is shown in FIG. 17.

Referring now to the algorithm for the Next function 174 shown in FIG. 16, the server next determines what is the specified sort direction (ascending or descending) (block 180). Next it is determined whether the last sort property value is null (or non-specified) (block 182). Note that the order of blocks 180 and 182 is not important and hence their order may differ from that shown in FIG. 16 (i.e., switched order or in parallel). Thus, in the Next function 174, if the sort direction is ascending and the last sort value is null or unspecified, the set mathematics of block 184 are performed. If the sort direction is ascending and the last sort value is not null, the set mathematics of block 186 are performed. If the sort direction is descending and the last sort value is null or unspecified, the set mathematics of block 188 are performed. If the sort direction is descending and the last sort value is not null or unspecified, the set mathematics of block 190 are performed.

Referring to block 184, in this case the query is executed against a subset of the underlying data store reduced to the following set of objects: (A intersect B) union C, where A is the subset of objects having the sort property value of null, B is the subset of objects having an OID value greater than the last OID value from the prior result set block (from block 164 in FIG. 15), and C is the subset of objects having a non-null sort property value.

Referring to block 186, in this case the query is executed against a subset of the underlying data store reduced to the following set of objects: (A intersect B) union C, where A is the subset of objects having a sort property value the same as the last sort property value from the prior result set block (from block 164 in FIG. 15), B is the subset of objects having an OID value greater than the last OID value from the prior result set block (from block 164), and C is the subset of objects having a sort property value greater than the last sort value property value from the prior result set block (from block 164).

Referring to block 188, in this case the query is executed against a subset of the underlying data store reduced to the following set of objects: A intersect B, where A is the subset of objects having the sort property value of null, and B is the subset of objects having an OID value less than the last OID value from the prior result set block (from block 164).

Referring to block 190, in this case the query is executed against a subset of the underlying data store reduced to the following set of objects: (A intersect B) union (C union D), where A is the subset of objects having a sort property value the same as the last sort property value from the prior result set block (from block 164), B is the subset of objects having an OID value less than the last OID value from the prior result set block (from block 164), C is the subset of objects having a sort property value less than the last sort value property value from the prior result set block (from block 164), and D is the subset of objects having the sort property value of null.

After performing the set mathematics in block 184, 186, 188, or 190, the results are ordered first by the sort property, then by OID, in the specified sort direction (i.e., from block 164) (see block 192). Next, the first m number of objects (based on the block size (m)) in the ordered result set is retrieved for being sent to the user (block 194). Then after the Next function is performed, the algorithm returns (see block 196) to block 164 in FIG. 15.

Referring now to the algorithm for the Previous function 176 shown in FIG. 17, the algorithm for the Previous function 176 is similar to that of the Next function 174. The server determines what is the specified sort direction (ascending or descending) (block 200), and the server determines whether the last sort property value is null (or non-specified) (block 202). The order of blocks 200 and 202 may vary (e.g., switched order or in parallel). Thus, in the Previous function, if the sort direction is ascending and the last sort value is null or unspecified, the set mathematics of block 204 are performed. If the sort direction is ascending and the last sort value is not null, the set mathematics of block 206 are performed. If the sort direction is descending and the last sort value is null or unspecified, the set mathematics of block 208 are performed. If the sort direction is descending and the last sort value is not null or unspecified, the set mathematics of block 210 are performed.

Referring to block 204, in this case the query is executed against a subset of the underlying data store reduced to the following set of objects: A intersect B, where A is the subset of objects having the sort property value of null, and B is the subset of objects having an OID value less than the first OID value from the prior result set block (from block 164 of FIG. 15).

Referring to block 206, in this case the query is executed against a subset of the underlying data store reduced to the following set of objects: (A intersect B) union (C union D), where A is the subset of objects having a sort property value the same as the first sort property value from the prior result set block (from block 164), B is the subset of objects having an OID value less than the first OID value from the prior result set block (from block 164), C is the subset of objects having a sort property value less than the first sort value property value from the prior result set block (from block 164), and D is the subset of objects having the sort property value of null.

Referring to block 208, in this case the query is executed against a subset of the underlying data store reduced to the following set of objects: (A intersect B) union C, where A is the subset of objects having the sort property value of null, B is the subset of objects having an OID value greater than the first OID value from the prior result set block (from block 164), and C is the subset of objects having a non-null sort property value.

Referring to block 210, in this case the query is executed against a subset of the underlying data store reduced to the following set of objects: (A intersect B) union C, where A is the subset of objects having a sort property value the same as the first sort property value from the prior result set block (from block 164), B is the subset of objects having an OID value greater than the first OID value from the prior result set block (from block 164), and C is the subset of objects having a sort property value greater than the first sort value property value from the prior result set block (from block 164).

After performing the set mathematics in block 204, 206, 208, or 210, the results are ordered first by the sort property, then by OID, in the opposite direction of the specified sort direction (i.e., from block 164) (block 212). For example, if the specified sort direction is ascending, then sort descending at block 212. Next, the first m number of objects (based on the block size (m)) in the ordered result set is retrieved for being sent to the user (block 214). Then the results are ordered again, first by the sort property, then by OID, in the specified sort direction (i.e., from block 164) (block 216). Then after the Previous function 176 is performed, the algorithm returns (block 218) to block 164 in FIG. 15. After block 164 in FIG. 15, the result set that has been limited as requested is ready to be sent to the client.

Next an example use of the Stateless Cursor Algorithm will be discussed with reference to FIGS. 1 and 2. In FIG. 1, the user has clicked on Accounts under My Customers in the left frame. By doing so, the user has submitted a query (block 150 in FIG. 15) for a set of objects relating to Accounts. The right frame in FIG. 1 shows the results of that query. The block size in this case is set to 20 by default (i.e., m=20). Initially, the default sort property is Operator Name and the default sort direction is ascending. Hence, initially no optional query information is provided (see block 154 in FIG. 15). The query results are also sorted by the OID property, although the OID values are not shown to the user and thus are not shown in FIGS. 1 and 2. Because the block size is bounded (see block 160) and the query results (23 objects) are larger than the specified block size (m=20) (see block 166), the first 23 objects of the ordered result set are retrieved from the database. Then, the output meta-information is generated and returned to the client (see block 164). In this example, the following values are returned: Sort property=Operator Name; Sort direction=ascending; m=20; Total object count in current result set block=20; Total object count in result set=23; First sort property value=Apache Corporation; First OID=8fe88fb88d19401b85df7e7a3343347b95 (not shown in FIG. 1); Last sort property value=Fina Oil & Chemicals Company; and Last OID=218fe215f4c24ca9971a164dd507249a45 (also not shown in FIG. 1). Also, the retrieved result set (from block 168) is sent to the client for display at the user's machine. After sending the results to the client, the server's resources are no longer tied up with the query request nor the query results. A session is not maintained at the server for the client.

When the user clicks on the button labeled “Next 3>>” shown in the top-right corner of FIG. 1, the user is making a request for the next group of objects from the query results (see block 150). At this point, the user has initiated another iteration through the Stateless Cursor Algorithm. Because the server has not maintained or held open a session for the user and the server is not responsible for maintaining state for the user, the user sends information to the server regarding the current state of the user, which includes at least part of the information of block 164. The meta-information from the prior query from block 164 is then used to provide the information needed in block 152 for the current request and next iteration through the Stateless Cursor Algorithm. Hence, in this iteration through the Stateless Cursor Algorithm optional query information is specified (see block 154).

The block size is inferred to be bounded and the last known block is inferred to be a subset of the total result set (see block 170). Because the defined navigation action is to scroll forward in the result set, the Next function 174 is called (see FIG. 16).

Because the specified sort direction is ascending (still at default setting) and the last sort property value (Fina Oil & Chemicals Company in FIG. 1) is not null, set mathematics of block 186 in FIG. 16 is executed. The server performs the Accounts query again and then limits the query results in accordance with the set mathematics shown in block 186. Hence for this example, A will be the subset of objects from the query results set having an Operator Name property value of “FINA Oil & Chemicals Company.” B will be the subset of objects from the query results set having an OID property value (not shown) greater than the last OID value. C will be the subset of objects from the query results set having an Operator Name property value alphabetically after the string “FINA Oil & Chemicals Company.” The intersect of A with B will provide all objects in the query results set having an Operator Name property value the same as the string ““FINA Oil & Chemicals Company” and having an OID property value string greater than the last OID property value of the prior block. The union of this AB intersection with C will combine the results of the AB intersection objects with the objects having an Operator Name property value alphabetically greater than the string ““FINA Oil & Chemicals Company,” with any duplicates removed.

The resulting objects from the set mathematics operation of block 186 will then be put in order first by the sort property Operator Name, and then by the OID property values for like Operator Names in an ascending order (see block 192). Next, the first 20 objects are retrieved from that ordered subset (based on the inferred block size of m=20), which in this case is only three objects (the remainder of the objects in the query results set) (see block 194). The criteria for the current state of the user is then updated (see block 164 in FIG. 15) and returned to the client along with the next three records, as shown in FIG. 2.

An advantage to performing the query each time the user makes another request is that the user is always getting the latest and most updated dated. For example, if a second user updated the phone number for Tom Brown, Inc. while a first user was viewing the query results block shown in FIG. 1, when the first user clicks on “Next 3>>,” the first user will have the updated phone number for Tom Brown, Inc. Rather than getting the old phone number for Tom Brown, Inc. that was obtained by the first query, although not shown to the user while not being a part of the block for objects 1-20, the first user has the latest information, as input by the second user (during the display of FIG. 1 and before the request for FIG. 2).

Another advantage of the Stateless Cursor Algorithm of the first embodiment is that the current state of the user does not have to be stored at the server because the user's machine keeps track of that information while it is being displayed at the user's machine. Also, a session does not have to be held open for the user at the server, which would tie up server resources. When the user submits the next request, the current state of the user can be determined by the server based on the information of block 164 being sent to the server, which is very little data, as it is only a string of character no longer than nine lines. Typically such information sent up to the server will be less than 100 kB of data. Thus, this allows the server resources to be freed up faster to server many more users using the same amount of server resources.

The Dynamic Thin Client architecture (see FIGS. 14A and 14B) and the Stateless Cursor Algorithm (see FIGS. 15-17) work in concert to provide a very optimized system that maximizes the use of system server resources, minimizes the size of information sent between the server and the client, minimizes the client browser's dependence for being connected to and using server resources while still provide robust functionality.

It will be appreciated by those skilled in the art having the benefit of this disclosure that an embodiment of the present invention provides improved ways to manage and access data. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A method of providing a software application to a user at a client via a web browser from a server, comprising:
after the user first goes to a specified URL corresponding to the server, generating computer-executable code in a scripting language at the server, wherein the scripting language is capable of being interpreted and run on the web browser at the client without using server resources, wherein the code includes static libraries and dynamically generated libraries of functions;
sending the generated code to the client over the Internet; and
executing the code on the web browser at the client using client resources to provide the software application to the user at the client via the web browser.

2. The method of claim 1, further comprising:
after the user closes the web browser at the client, freeing up the client resources consumed during the execution of the code for providing the software application.

3. The method of claim 1, wherein the software application is adapted to provide a graphical user interface for accessing and managing information.

4. The method of claim 1, wherein the sending of the generated code is performed using an Internet-based protocol.

5. The method of claim 1, wherein the static libraries are reusable generic functions for interacting with information substantially independent of a particular manifestation of the information, and wherein the dynamically generated libraries are functions adapted to be compatible with the client resources at the client and chosen based upon the client resources that will be used at the client to execute the code.

6. The method of claim 1, wherein the code includes functions for performing at least one of deconstructing data, serializing data, deserializing data, and reconstructing data.

7. The method of claim 6, further comprising:
deconstructing data at the server;
serializing the deconstructed data at the server; and
sending the serialized data to the client.

8. The method of claim 7, further comprising:
compressing the serialized data at the server.

9. The method of claim 7, further comprising:
receiving the serialized data at the client; and
deserializing the data at the client using the software application being executing on the web browser using the client resources, wherein the de-serializing includes reconstructing the data at the client using the software application being executed on the web browser using the client resources.

10. The method of claim 6, further comprising:
deconstructing data at the client using the software application being executing on the web browser using the client resources, wherein the data includes a request for information;
serializing the deconstructed data at the client using the software application being executing on the web browser using the client resources; and
sending the serialized data to the server.

11. The method of claim 10, further comprising:
compressing the serialized data at the client using the software application being executing on the web browser using the client resources.

12. The method of claim 10, further comprising:
receiving the serialized data at the server;
deserializing the data at the server, wherein the deserializing includes reconstructing the data at the server.

13. The method of claim 1, further comprising:
receiving a request for information in a data repository from the client at the server via the software application being executed on the web browser at the client;
communicating with the data repository by the server to obtain the requested information;
serializing the information in the form of dense and interpretable object constructors;
sending the serialized information to the client via the Internet;
receiving the serialized information at the client;
deserializing and reconstructing the information at the client using the software application; and
providing a graphical user interface on the web browser at the client using the software application so that the user may access and manage the received information.

14. A method for providing functionality to a client by a server across a networked communication medium, the method comprising:
receiving a client-request from the client at the server, the client-request being based on a request inputted by a user;
generating a set of computer-executable codes by the server for providing functionality corresponding to the client-request after receiving the client-request; and
forwarding the generated set of computer-executable codes to the client for execution, wherein the functionality is provided to the user by the client.

15. The method of claim 14, wherein the generating further comprises:
obtaining a first subset of the computer-executable codes from a static library of codes in communication with the server; and
dynamically generating a second subset of the computer-executable codes based on a meta-information set received from a data repository system in communication with the server.

16. The method of claim 15, wherein the first and second subset of computer-executable codes are codes for at least one of providing logical functionality components of the functionality, and creating visual functionality components of the functionality for presenting the logical functionality component to the user by the client.

17. The method of claim 16, wherein the creating comprises:
determining the visual functionality components required for presenting the logical functionality components to the user by the client based on the received client-request; and
generating the set of computer-executable codes for the required visual functionality components by the obtaining of the first subset and dynamically generating the second subset required for the required visual functionality components.

18. The method of claim 17, wherein the first subset obtained for the required visual functionality components includes code for a structure and a presentation form of the visual functionality components.

19. The method of claim 18, wherein the dynamically generating the second subset of computer-executable codes further comprises:
requesting from the data repository system a set of process-specific logic information and schema-specific logic information corresponding to the functionality based on the received client-request;
receiving the meta-information set from the data repository system wherein the meta-information set corresponds to the requested set of logic information; and
converting the meta-information set into a computer-executable code of a format executable by the client, wherein the second subset includes the converted meta-information set.

20. The method of claim 19, wherein the meta-information set includes a set of logic for performing a calculation among interrelated objects.

21. The method of claim 15, wherein the obtained first subset of computer-executable codes from the static library of codes is for a process of validating a user-inputted record.

22. The method of claim 19 further comprising:
instructing the client to invoke execution of the received computer-executable code based on the occurrence of a predetermined user-inputted request.

23. The method of claim 19, wherein the format is a computer executable script.

24. The method of claim 23, wherein the script is a JavaScript.

25. The method of claim 14,
wherein the networked communication medium is the Internet, and
wherein the client includes a client web-browser application for receiving the request inputted by the user, for communicating the client-request with the server in the form of an Internet-based communication across the Internet, and for presenting the user-interface to the user.

26. The method of claim 14, further comprising:
communicating by the server with the client based on an initial request by the client prior to receiving the client-request; and
terminating the communication by the server with the client subsequent to the forwarding, wherein the functionality is provided to the user by the client after the terminating.

27. A method for providing functionality to a user by a client based on a user-inputted request, the method comprising:
forwarding the user-inputted request to a server in communication with the client across a networked communication medium;
receiving from the server a set of computer-executable codes generated by the server for providing functionality at the client; and
executing the received set of computer-executable codes by the client, wherein the functionality is provided to the user by the client.

28. The method of claim 27, wherein the received set of computer-executable codes includes at least one of a first subset of codes providing logical functionality components of the functionality and a second subset of codes for creating visual functionality components of the functionality for presenting the logical functionality components to the user by the client.

29. The method of claim 28, wherein the first subset of codes includes codes for a structure and a presentation form of the visual functionality components.

30. The method of claim 29, wherein the received set of computer-executable codes includes a set of system-level logic information, a set of process-specific logic information, a set of schema-specific logic information corresponding to the functionality, and a set of information objects.

31. The method of claim 30, further comprising:
storing the received set of computer-executable codes in a client memory; and
allocating client system resources for the storing and execution of the received set of computer-executable codes.

32. The method of claim 31, further comprising:
instantiating the received system-logic information for a full duration of a user-interaction, wherein the system-logic information are received at the beginning of the user-interaction from the server.

33. The method of claim 32, wherein the system-logic information includes processes for the client to perform at least one of a re-constructing, serializing and de-serializing the computer-executable codes received from the server and client-requests forwarded to the server during the user-interaction with the server.

34. The method of claim 33, further comprising:
deleting the received set of computer-executable codes corresponding to the received set of system-level logic information from the client memory; and
freeing the client system resources allocated for the storage and execution of the deleted set of computer-executable codes, wherein the deleting and freeing occurs at the end of the user-interaction.

35. The method of claim 30, wherein the schema-specific logic information include information for at least one of creating a new computer executable object, deleting the object, and updating the object.

36. The method of claim 27,
wherein the networked communication medium is the Internet, and
wherein the client includes a client web-browser application for receiving the request inputted by the user, for communicating the client-request with the server in the form of an Internet-based communication across the Internet, and for presenting a graphical user-interface to the user.

37. The method of claim 27, further comprising:
communicating by the server with the client based on an initial request by the client prior to receiving the client-request; and
terminating the communication by the server with the client subsequent to the forwarding, wherein the requested functionality is provided to the user by the client after the terminating.

38. A method for interacting between a server and a client across a networked communication medium for providing functionality to the client by the server, the method comprising:
forwarding a client-request for the functionality to the server by the client, wherein the client-request is based on a request inputted by a user;
receiving the client-request by the server;
generating a set of computer-executable codes by the server for providing the functionality after receiving the client-request;
forwarding the generated set of computer-executable codes to the client;
receiving the forwarded set of computer-executable codes by the client;
executing the received set of computer-executable codes by the client; and
providing the functionality to the user by the client.

39. The method of claim 38, wherein the forwarding to the server comprises: serializing the client-request for the requested functionality by the client based on a predetermined serialization process.

40. The method of claim 39, wherein the receiving the client-request by the server comprises: de-serializing the received client-request by the server based on a predetermined de-serialization process wherein the de-serializing includes reconstructing the de-serialized client-request based on a predetermined reconstruction process.

41. The method of claim 39, wherein the serialized client-request is a normalized serialized client-request.

42. The method of claim 39, wherein the client-request is a set of computer-executable objects and wherein the serialized client-request is a serialized interpretable object constructors client-request.

43. The method of claim 38, wherein the forwarding the generated set of computer-executable codes to the client comprises:
serializing the generated set of computer-executable codes by the server based on a predetermined serialization process.

44. The method of claim 43, wherein the receiving the forwarded set of computer-executable codes by the client comprises:
de-serializing the generated set of computer-executable codes received by the client based on a predetermined de-serialization process, wherein the de-serializing includes reconstructing the de-serialized set of computer-executable codes based on a predetermined reconstruction process.

45. The method of claim 43, wherein the serialized generated set is a normalized serialized set.

46. The method of claim 43, wherein the set of computer-executable codes is a set of computer-executable objects and wherein the serialized generated set is a serialized interpretable object constructors set.

47. The method of claim 44, wherein the client reconstructs the de-serialized generated set of computer-executable codes without communication with the server.

48. The method of claim 38,
wherein the networked communication medium is the Internet, and
wherein the client includes a client web-browser application for receiving the request inputted by the user, for communicating the client-request with the server in the form of an Internet-based communication across the Internet, and for presenting a graphical user-interface to the user.

49. The method of claim 38, further comprising:
communicating by the server with the client based on an initial request by the client prior to receiving the client-request; and
terminating the communication by the server with the client subsequent to the forwarding, wherein the functionality is provided to the user by the client after the terminating.

50. The method of claim 38, wherein the networked communication medium includes at least one of a wireless communication medium and a landline communication medium.

51. A method for providing functionality to a client by a server across a networked communication medium, the method comprising:
receiving a client-request from the client at the server, the client-request being based on a request inputted by a user;
generating a set of computer-executable codes by the server for providing functionality corresponding to the client-request after receiving the client-request;
forwarding the generated set of computer-executable codes to the client for execution, wherein the functionality is provided to the user by the client;
communicating by the server with the client based on an initial request by the client prior to receiving the client-request; and
terminating the communication by the server with the client subsequent to the forwarding, wherein the functionality is provided to the user by the client after the terminating.

52. A method of providing functionality and presenting information to a user by a client, comprising:
receiving an initial client communication over a networked communication medium from the client at a server;
forwarding a first set of computer-executable code including a set of system-level logic to the client by the server;
executing the first set of code by the client for instantiating the system-level logic at the client;
receiving an information insight request from the client at the server, the information insight request being based on a user input at the client;
generating a second set of computer-executable codes by the server, the second set of computer-executable code adapted to fulfill the information insight request, the second set of code including a set of process-specific logic, a set of schema-specific logic corresponding to the functionality, and a set of information objects;
forwarding the second set of computer-executable codes to the client by the server;
executing the second set of computer-executable codes by the client;
presenting at least part of the set of information objects to the user by the client; and
providing functionality by the client so that the user can interact with the presented objects in accordance with the schema-specific logic.
